(19) United States
(12) Patent Application Publication
(10) Pub. No.: US 2014/0302419 A1
(43) Pub. Date: Oct. 9, 2014

(54) MEMBRANE ELECTRODE ASSEMBLY FOR FUEL CELL

(71) Applicants: Ryoichi Nanba, Susono-shi (JP); Hikaru Hasegawa, Susono-shi (JP)

(72) Inventors: Ryoichi Nanba, Susono-shi (JP); Hikaru Hasegawa, Susono-shi (JP)

(73) Assignee: TOYOTA JIDOSHA KABUSHIKI KAISHA, Toyota-shi (JP)

(21) Appl. No.: 14/355,695

(22) PCT Filed: Sep. 3, 2012
(86) PCT No.: PCT/JP2012/072369

§ 371 Date: May 1, 2014

(30) Foreign Application Priority Data
Nov. 4, 2011 (JP) 2011-242686

(51) Int. Cl. H01M 8/10

(52) U.S. Cl. CPC H01M 8/1004
USPC 429/482

(57) ABSTRACT

A membrane electrode assembly for a fuel cell that can prevent a conductive nano columnar body from being embedded in an electrolyte membrane and can efficiently use a catalyst is provided. A membrane electrode assembly for a fuel cell includes: at least, an electrolyte membrane; and at least one electrode that includes conductive nano columnar bodies that are disposed at least on one surface of the electrolyte membrane and are oriented in a nearly vertical direction to a surface direction of the electrolyte membrane and a catalyst supported by the conductive nano columnar body, wherein the electrode membrane includes at least one proton conductive layer and at least one preventive layer for preventing conductive nano columnar bodies from being embedded; the preventive layer for preventing conductive nano columnar bodies from being embedded is disposed between an interface between the electrode and the electrolyte membrane and a center of the electrolyte membrane in a thickness direction; and the proton conductive layer occupies a portion other than a portion in which the preventive layer for preventing conductive nano columnar bodies from being embedded is disposed in the electrolyte membrane.

### TECHNICAL FIELD

The present invention relates to a membrane electrode assembly for a fuel cell that can prevent conductive nano columnar bodies from being embedded in an electrolyte membrane and can efficiently use a catalyst.

### BACKGROUND ART

A fuel cell supplies a fuel and an oxidant to two electrodes that are electrically connected, electrochemically induces oxidation of the fuel, and directly converts chemical energy into electrical energy thereby. Different from thermal power generation, since the fuel cell is not subjected to Carnot cycle restraint, a high energy conversion efficiency can be obtained. The fuel cell is usually configured by stacking several layers of a unit cell that has a membrane electrode assembly that sandwiches an electrolyte membrane with a pair of electrodes as a fundamental structure.

An electrochemical reaction in an anode and a cathode of the fuel cell proceeds when a gas such as a fuel gas and an oxidant gas is introduced to a three phase interface that is a contact surface of catalyst particles supported on a carrier that is conductive material and a polymer electrolyte that ensures an ion conducting path.

An electrode reaction in each of an anode side catalyst layer and a cathode side catalyst layer is more active when an amount of the catalyst supported on carbon particles such as carbon black is abundant, and power generation performance of a battery is improved. However, since the catalyst used in the fuel cell is a noble metal such as platinum, when a supported amount of the catalyst is increased, there is a problem that a manufacturing cost of the fuel cell increases.

Further, in a reaction electrode in which the catalyst is supported on carbon particles, loss of electron conduction is caused between carbon particles and between carbon particles and a separator that is a current collector. The loss of electrons is considered to be a reason of a plateau in power generation performance.

As a technique to avoid problems such as the manufacturing cost and the loss of electrons, a fuel cell that uses carbon nano tubes (hereinafter, referred to as CNT in some cases) in an electrode is proposed. Since an electrode that uses the CNT has low electrical resistance, it is targeted to suppress the loss of electrons, to improve the power generation efficiency, and to efficiently use a supported expensive noble metal catalyst in the electrode reaction compared with the case where carbon particles support the catalyst.

From the advantages described above, a technical development that uses the CNT is now actively performed. Patent Document 1, for example, discloses a manufacturing method of a catalyst electrode that is used in a membrane electrode assembly for a fuel cell, which includes a CNT growth step of growing a plurality of CNTs that is oriented vertically to a surface of a substrate and has a corrugated shape having a specified wavelength, a catalyst metal supporting step of supporting a catalyst metal on a plurality of CNTs by dripping a catalyst metal salt solution on the plurality of CNTs and by reducing by drying and by sintering, and an ionomer coating step of coating a surface of the plurality of CNTs that support the catalyst metal with an ionomer by dripping an ionomer dispersed solution on the plurality of CNTs that support the catalyst metal and by drying the plurality of CNTs.

On the other hand, separately from the technique that uses the CNT, a technique that alleviates stress generated by expansion and shrinkage of an electrolyte membrane by disposing an electrolyte membrane that includes a reinforcing material is known. Patent Document 2 discloses a membrane electrode assembly for a solid polymer type fuel cell in which a solid polymer electrolyte membrane is formed by joining a cathode side electrolyte membrane disposed on a cathode electrode side and an anode side electrolyte membrane disposed on an anode electrode side, the cathode side electrolyte membrane is an ion exchange resin that includes a reinforcement material, and the anode side electrolyte membrane is an ion exchange resin that does not include the reinforcement material or is less in the content of the reinforcement material than that of the cathode side electrolyte membrane.

### PRIOR ART DOCUMENT

### Patent Documents

Patent Document 1: Japanese Patent Application Publication No. 2010-272437 (JP 2010-272437 A)
Patent Document 2: Japanese Patent Application Publication No. 2009-070675 (JP 2009-070675 A)

### SUMMARY OF THE INVENTION

### Problem to be Solved by the Invention

The Patent Document 1 describes to the effect that the CNT electrode manufactured on a substrate is transferred on a surface of an electrolyte membrane (claim 4 of the Patent Document 1). However, when the present inventors studied the manufacturing method of the CNT electrode disclosed in the Patent Document 1, it was found that there is a problem that a utilization rate of the catalyst metal supported on the CNT is degraded because a tip of the CNT is embedded in the electrolyte membrane when the CNT is transferred on the electrolyte membrane.

In Paragraph [0012] of the Patent Document 2, it is described to the effect that when the electrolyte membrane that includes an ion exchange resin different from each other is used on each of the cathode electrode side and the anode electrode side, the stress of the electrolyte membrane generated by expansion and shrinkage due to a dry/wet condition is alleviated, and the degradation of the electrolyte membrane due to thinning can be prevented thereby.

However, a conventional electrode that uses a carbon support as described in the Patent Document 2 is low in the porosity and an electrode material in a catalyst layer flows during a wet time, therefore the expansion and shrinkage of the catalyst layer is generated. On the other hand, the expansion and shrinkage of the electrolyte membrane is not caused due to a dry/wet condition of the CNT electrode, because it has high porosity. Therefore, because it is considered that the CNT electrode intrinsically has a function of suppressing swelling of the electrolyte membrane, by simply combining the technique of the CNT electrode and the technique relating the electrolyte membrane such as described in Patent Document 2, an operation described in the Patent Document 2 is difficult to occur in the CNT electrode, thus, an effect more than an expansion/shrinkage suppression effect of the electrolyte membrane that the CNT electrode intrinsically has cannot be expected.

The present invention was achieved in view of the above situation, and intends to provide a membrane electrode assembly for a fuel cell that can prevent conductive nano columnar bodies such as carbon nanotube from being embedded in an electrolyte membrane and can efficiently use a catalyst.

### Means for Solving the Problem

A membrane electrode assembly for a fuel cell according to the present invention includes at least an electrolyte membrane and at least one electrode that includes conductive nano columnar bodies that are disposed at least on one surface of the electrolyte membrane and are oriented in a nearly vertical direction to a surface direction of the electrolyte membrane and a catalyst supported by the conductive nano columnar body. The membrane electrode assembly is characterized in that the electrode membrane including at least one proton conductive layer and at least one preventive layer for preventing the conductive nano columnar body from being embedded; the preventive layer for preventing conductive nano columnar bodies from being embedded is disposed between an interface between the electrode and the electrolyte membrane and a center of the electrolyte membrane in a thickness direction; the proton conductive layer occupies a portion other than a portion in which the preventive layer for preventing conductive nano columnar bodies from being embedded in the electrolyte membrane is disposed.

In the present invention, the membrane electrode assembly for a fuel cell may include at least the electrolyte membrane and one of the electrode; the electrolyte membrane may include one of the proton conductive layer, and one of the preventive layer for preventing conductive nano columnar bodies from being embedded; the preventive layer for preventing conductive nano columnar bodies from being embedded may be disposed in the interface between the electrode and the electrolyte membrane; and the proton conductive layer may be disposed on a side opposite to the electrode with the preventive layer for preventing conductive nano columnar bodies from being embedded sandwiched therebetween.

In the present invention, the membrane electrode assembly for a fuel cell may include at least the electrolyte membrane and one of the electrode; the electrolyte membrane may include two of the proton conductive layer, and one of the preventive layer for preventing conductive nano columnar bodies from being embedded; the preventive layer for preventing conductive nano columnar bodies from being embedded may be disposed in the inside of the electrolyte membrane and between the interface between the electrode and the electrolyte membrane and the center of the electrolyte membrane in the thickness direction; and two of the proton conductive layer may occupy the portion other than the portion where the preventive layer for preventing conductive nano columnar bodies from being embedded is disposed in the electrolyte membrane.

In the present invention, the membrane electrode assembly for a fuel cell may include at least the electrolyte membrane, and two of the electrode; the electrolyte membrane may include one of the proton conductive layer, and two of the preventive layer for preventing conductive nano columnar bodies from being embedded; two of the preventive layer for preventing conductive nano columnar bodies from being embedded, respectively, may be disposed in an interface between the electrolyte membrane and one of the electrode and in an interface between the electrolyte membrane and the other of the electrode; and the proton conductive may be sandwiched by two of the preventive layer for preventing conductive nano columnar bodies from being embedded.

In the present invention, the membrane electrode assembly for a fuel cell may include at least the electrolyte membrane and two of the electrode; the electrolyte membrane may include two of the proton conductive layer, and two of the preventive layer for preventing conductive nano columnar bodies from being embedded; one of the preventive layer for preventing conductive nano columnar bodies from being embedded may be disposed in an interface between one of the electrode and the electrolyte membrane and the other of the preventive layer for preventing conductive nano columnar bodies from being embedded may be disposed in the inside of the electrolyte membrane and between an interface the other of the electrode and the electrolyte membrane and the center of the electrolyte membrane in the thickness direction; and two of the proton conductive layer may occupy a portion other than a portion where two of the preventive layer for preventing conductive nano columnar bodies from being embedded in the electrolyte membrane is disposed.

In the present invention, the membrane electrode assembly for a fuel cell may include at least the electrolyte membrane and two of the electrode; the electrolyte membrane may be include three of the proton conductive layer and two of the preventive layer for preventing conductive nano columnar bodies from being embedded; one of the preventive layer for preventing conductive nano columnar bodies from being embedded may disposed in the inside of the electrolyte membrane and between an interface between one of the electrode and the electrolyte membrane and the center of the electrolyte membrane in the thickness direction; the other of the preventive layer for preventing conductive nano columnar bodies from being embedded may be disposed in the inside of the electrolyte membrane and between an interface between the other of the electrode and the electrolyte membrane and the center of the electrolyte membrane in the thickness direction; and three of the proton conductive layer may occupy a portion other than a portion where two of the preventive layer for preventing conductive nano columnar bodies from being embedded are disposed in the electrolyte membrane.

In the present invention, the preventive layer for preventing conductive nano columnar bodies from being embedded preferably includes a proton conductive electrolyte resin and a porous resin harder than the proton conductive electrolyte resin.

In the present invention, a thickness of the preventive layer for preventing conductive nano columnar bodies from being embedded is preferably 1 to 10 μm.

In the present invention, a basis weight of the preventive layer for preventing conductive nano columnar bodies from being embedded is preferably 0.05 to 1.0 mg/cm².

In the present invention, when a total volume of the preventive layer for preventing conductive nano columnar bodies from being embedded is set to 100% by volume, a volume of the proton conductive electrolyte resin is preferably 10 to 90% by volume.

In the present invention, the preventive layer for preventing conductive nano columnar bodies from being embedded is preferably disposed in a portion having a thickness of 0 to 5 μm from an interface with the electrode toward a thickness direction of the electrolyte membrane.

In the present invention, the conductive nano columnar body is preferably a carbon nanotube.

In the present invention, the cathode electrode preferably includes the conductive nano columnar body.

In the present invention, the porosity of the preventive layer for preventing conductive nano columnar bodies from being embedded is 50% or more, and, a product of the thickness and the basis weight of the preventive layer for preventing conductive nano columnar bodies from being embedded is preferably 1.8×10⁻⁴ mg/cm or less.

### Effect of the Invention

According to the present invention, the conductive nano columnar body becomes difficult to be embedded in the electrolyte membrane during transfer when the preventive layer for preventing conductive nano columnar bodies from being embedded is disposed in the inside or on a surface of the electrolyte membrane. As a result, almost all of the catalyst supported by the conductive nano columnar body can effectively be utilized in the electrode reaction.

### BRIEF DESCRIPTION OF THE DRAWINGS

FIG. 1 is a diagram that schematically shows a first typical example of a membrane electrode assembly for a fuel cell according to the present invention and schematically shows a cross-section cut in a stacking direction.

FIG. 2 is a diagram that schematically shows a second typical example of the membrane electrode assembly for a fuel cell according to the present invention and schematically shows a cross-section cut in a stacking direction.

FIG. 3 is a diagram that schematically shows a third typical example of the membrane electrode assembly for a fuel cell according to the present invention and schematically shows a cross-section cut in a stacking direction.

FIG. 4 is a diagram that schematically shows a fourth typical example of the membrane electrode assembly for a fuel cell according to the present invention and schematically shows a cross-section cut in a stacking direction.

FIG. 5 is a diagram that schematically shows a fifth typical example of the membrane electrode assembly for a fuel cell according to the present invention and schematically shows a cross-section cut in a stacking direction.

FIG. 6 is a SEM image of a cross-section of the membrane electrode assembly according to Example 6 cut in a stacking direction.

FIG. 7 shows discharge curves of the membrane electrode assemblies according to Example 6 and Comparative Example 1.

FIG. 8 is a bar chart in which area resistances (mΩ·cm²) or short-circuit resistances (Ω) according to Example 6 and Comparative Example 1 are compared.

FIG. 9 shows discharge curves of the membrane electrode assemblies according to Example 1 and Comparative Example 1.

FIG. 10 is a bar chart in which area resistances at the current density of 2.0 A/cm² of the membrane electrode assemblies according to Example 1 and Comparative Example 1 are compared.

FIG. 11 shows discharge curves of the membrane electrode assemblies according to Example 2, Example 3, and Comparative Example 1.

FIG. 12 shows discharge curves of the membrane electrode assemblies according to Example 4-Example 6, and Comparative Example 1.

FIG. 13 shows discharge curves of the membrane electrode assemblies according to Reference Example 2, Reference Example 3, and Comparative Example 1.

FIG. 14 is a schematic cross-sectional view of a conventional membrane electrode assembly that uses a CNT electrode.

### MODES FOR CARRYING OUT THE INVENTION

A membrane electrode assembly for a fuel cell according to the present invention includes at least an electrolyte membrane and at least one electrode that includes conductive nano columnar bodies that are disposed at least on one surface of the electrolyte membrane and are oriented in a nearly vertical direction to a surface direction of the electrolyte membrane and a catalyst supported by the conductive nano columnar body, in which the electrode membrane includes at least one proton conductive layer and at least one preventive layer for preventing conductive nano columnar bodies from being embedded, the preventive layer for preventing conductive nano columnar bodies from being embedded is disposed between an interface between the electrode and the electrolyte membrane and a center of the electrolyte membrane in a thickness direction, the proton conductive layer occupies a portion other than a portion in which the preventive layer for preventing conductive nano columnar bodies from being embedded in the electrolyte membrane is disposed.

As a reason why the platinum utilization rate in the CNT electrode decreases, the following three are mainly considered. That is, (1) a lack of the proton conductive passage because an ionomer is not coated on the CNT, (2) disconnection of the conductive passage due to contact defect between the CNT electrode and the porous layer, and (3) disconnection of a gas conduction passage to the catalyst metal because the catalyst metal is embedded in the electrolyte membrane.

As described above, an active research and development of a method of manufacturing a membrane electrode assembly for a fuel cell, in which the CNT electrode grown on a surface of a base material is transferred on an electrolyte membrane is under way. However, an attention has not been paid on the reason of the (3), in particular, on the demerit of embedding the CNT on which the catalyst is supported in the electrolyte membrane during transfer. Rather, it has been considered that it is preferable to embed the CNT in the electrolyte membrane in order to reduce the resistance of the interface between the electrolyte membrane and the CNT electrode.

FIG. 14 is a schematic cross-sectional view of a conventional membrane electrode assembly that uses the CNT electrode. To an electrolyte membrane 1, a CNT 2a is oriented in a nearly vertical direction. The CNT 2a supports a catalyst 3 and is coated with an electrolyte resin 4, and the CNT 2a, the catalyst 3, and the electrolyte resin 4 form a catalyst layer 5. The conventional membrane electrode assembly 600 includes a porous layer 6 and a gas diffusion layer 7 in this order on a side opposite to the electrolyte membrane 1 with the catalyst layer 5 sandwiched therebetween.

In the conventional membrane electrode assembly 600, a part 5a of the catalyst layer is embedded in the electrolyte membrane 1. Thus, a tip of the CNT 2a on the electrolyte membrane side and a part of the catalyst 3 are embedded in the electrolyte membrane 1.

The inventors found a problem that, during thermal transfer, about 1 to 2 μm of the tip of the CNT is embedded in the electrolyte membrane, and due to the embedment of the catalyst supported by the CNT in the electrolyte membrane, a fuel gas or an oxidizing gas does not reach the embedded catalyst, as a result, the embedded catalyst cannot contribute to an electrode reaction, and about 30% of the catalyst activity decreases. The inventors, after studying hard, solved the problem by disposing a layer for preventing conductive nano columnar bodies such as the CNT from being embedded in the inside or on a surface of the electrolyte membrane, and found that the utilization rate of the catalyst such as platinum can be improved, thus, the present invention was completed.

A mechanism by which the catalyst is embedded in the electrolyte membrane due to the CNT will be described below with reference to a conventional electrode that uses spherical carbon.

As a method of manufacturing a conventional electrode that uses spherical carbon, a method where an ink of spherical carbon on which platinum is supported and an ionomer is rendered pasty, and the paste is transferred on an electrolyte membrane, a method of directly spraying the ink to the electrolyte membrane, and a method of die-coating the ink on the electrolyte membrane can be exemplified. A solid content ratio of the catalyst layer in the manufactured electrode is about 40 to 50%. Therefore, since a contact area between the electrolyte membrane and the catalyst layer during transfer is relatively large, local surface pressure during transfer is small, and the spherical carbon is difficult to be embedded in the electrolyte membrane.

On the other hand, the CNT electrode has a structure where an ionomer adheres to an assembled structure of slender CNTs of about 20 nm, and a solid content ratio thereof is about 20% or less. Further, since a tip of the CNT is slender such as about 20 nm, an effective installation area of the CNT when transferring the electrolyte membrane is small, and a local surface pressure during transfer is larger than a local surface pressure during transfer of the conventional electrode that uses spherical carbon. Therefore, even under the transfer pressure the same as that of a manufacturing method that uses spherical carbon, the CNT is likely to be embedded in the electrolyte membrane.

In order to solve the problem described above, it is considered to optimize transfer conditions such as a surface pressure, a temperature, and a time. However, condition ranges of the transfer temperature and pressure are very narrow and lack in generality. Further, although a transfer performance can be improved when the transfer temperature is raised, there is a risk that the electrolyte membrane is denatured or an amount of platinum that is embedded in the electrolyte membrane increases. On the other hand, when the transfer pressure is raised, although the transfer performance can be improved, there is a risk that pores in the catalyst layer decrease, a three phase interface where an electrode reaction proceeds decreases, and an amount of platinum embedded in the electrolyte membrane increases.

Thus, since there is always a tradeoff and it is difficult to optimize the transfer temperature and pressure, the inventors considered to dispose, as a fundamental improvement measure, a layer that prevents conductive nano columnar bodies from being embedded in the inside or on a surface of the electrolyte membrane.

A membrane electrode assembly for a fuel cell according to the present invention includes at least an electrolyte membrane and an electrode. Hereinafter, these battery members which are used in the present invention will be described in sequence.

1. Electrolyte Membrane

The electrolyte membrane used in the present invention includes at least one proton conductive layer, and at least one preventive layer for preventing conductive nano columnar bodies from being embedded. The electrolyte membrane used in the present invention is a membrane obtained by stacking the proton conductive layer and the preventive layer for preventing conductive nano columnar bodies from being embedded.

Hereinafter, the proton conductive layer and the preventive layer for preventing conductive nano columnar bodies from being embedded will be sequentially described.

1-1. Proton Conductive Layer

The proton conductive layer in the electrolyte membrane used in the present invention is not particularly restricted as long as it contains a proton conductive electrolyte that can be used in a fuel cell. Examples of the proton conductive electrolytes used in the proton conductive layer include, other than fluorinated polymer electrolytes such as perfluorocarbon sulfonic acid resin represented by NAFION (trade mark) that is a proton conductive polymer electrolyte used in the fuel cell, engineering plastics such as polyether ether ketone, polyether ketone, polyether sulfone, polyphenylene sulfide, polyphenylene ether, and polyparaphenylene; and hydrocarbon polymer electrolytes obtained by introducing a protonic acid group (proton conductive group) such as a sulfonic acid group, a carboxylic acid group, a phosphoric acid group or boronic acid group in hydrocarbon polymers such as general use plastics such as polyethylene, polypropylene, and polystyrene.

The proton conductive layer occupies a portion other than a portion where the protective layer for preventing conductive nano columnar bodies from being embedded is disposed in the electrolyte membrane. In other words, in the electrolyte membrane, all of a portion that is not the preventive layer for preventing conductive nano columnar bodies from being embedded is the proton conductive layer.

1-2. Preventive Layer for Preventing Conductive Nano Columnar Body from being Embedded

The preventive layer for preventing conductive nano columnar bodies from being embedded (hereinafter, referred to as an embedment preventive layer in some cases) is a layer having a function of preventing a part of the conductive nano columnar body from being embedded in the electrolyte membrane when the conductive nano columnar body is transferred on the electrolyte membrane. The specific physical property of the embedment preventive layer is determined based on the tradeoff between the proton conductivity that can ensure a proton conductive passage to the catalyst on a surface of the conductive nano columnar body and the mechanical strength that can prevent the conductive nano columnar body from being embedded into the inside of the electrolyte membrane.

The embedment preventive layer preferably includes a proton conductive electrolyte resin and a porous resin harder than the proton conductive electrolyte resin. According to this aspect, the proton conductive electrolyte resin mainly controls the proton conductivity and the hard porous resin described above mainly controls the mechanical strength. Therefore, the optimum physical property of the embedment preventive layer is determined by determining a content ratio of the proton conductive electrolyte resin and the porous resin in the embedment preventive layer.

The embedment preventive layer may be a layer obtained by blending the proton conductive electrolyte resin in a base material with the hard porous resin as the base material or may be a layer obtained by blending the more harder porous resin described above in the base material with the proton conductive electrolyte resin as the base material.

As the proton conductive electrolyte resin that can be used in the embedment preventive layer, the same as the proton conductive electrolytes used in the proton conductive layer can be used. An ion exchange amount of the proton conductive electrolyte resin is preferably IEC 1.0 meq/g or more, more preferably IEC 1.35 meq/g or more, and still more preferably IEC 1.5 meq/g or more. Further, it may be IEC 2.2 meq/g or less.

In the present invention, the “hard” indicates performance having high hardness. Here, the “hardness” indicates the mechanical strength. Therefore, without limiting to the hardness generally known as the hardness (so-called scratch hardness) such as so-called Mohs hardness or Vickers hardness, breaking strength (breaking energy), shearing stress, yielding stress and the like are contained in the “hardness” here.

As an index of the hardness in the present invention, for example, the Mohs hardness described above can be used. Table 1 below is a table in which Mohs hardness and kinds of corresponding typical materials are listed. For example, PTFE described in a column of Mohs hardness 2 is not bruised when scratched with plaster that is a reference substance of Mohs hardness 2 but bruised when scratched with calcite that is a reference substance of Mohs hardness 3.

TABLE 1

| Mohs hardness | Kinds of materials |
|---|---|
| 1 | Clay, talc, perfluorocarbon sulfonic acid resin |
| 2 | PTFE, plaster, nylon, gold, silver |
| 3 | Mica, rock salt |
| 4 | Zinc, copper, platinum, palladium |
| 5 | Glass |
| 6 | Hematite, lime glass, iridium |
| 7 | Quartz, rock crystal |
| 8 | Zirconia |
| 9 | Alumina, sapphire |
| 10 | Diamond |

According to the Table 1 described above, the Mohs hardness of the perfluoro carbon sulfonic acid resin is 1.0 to 1.9. Therefore, the Mohs hardness of the porous resin that can be used in the embedment preventive layer is preferably higher than 1.9. For example, since the Mohs hardness of the PTFE is 2, a combination of the PTFE porous resin and the perfluorocarbon sulfonic acid resin is preferable as a combination of materials used in the embedment preventive layer of the present invention.

As the hard porous resins that can be used in the present invention, other than the PTFE, a polyolefin resin, polytetrafluoro ethylene, a polytetrafluoroethylene-chlorotrifluoroethylene copolymer, polychlorotrifluoroethylene, polybromotrifluoroethylene, a polytetrafluoroethylene-bromotrifluoroethylene copolymer, a polytetrafluoroethylene-perfluorovinyl ether copolymer, polytetrafluoroethylene-hexafluoropropylene copolymer can be used.

Further, the hard porous resin used in the present invention is preferably a stretched porous film.

When the embedment preventive layer is formed in such a manner that with the porous resin as the base material, the proton conductive electrolyte resin is introduced in pores of the porous resin, a content ratio of the proton conductive electrolyte resin and the porous resin in the embedment preventive layer is determined by the porosity in the porous resin, for example. This is because the porosity of the porous resin corresponds to the filling rate of the proton conductive electrolyte resin in the pores.

When a material of the porous resin is concretely determined and a desired basis weight and a thickness of the embedment preventive layer are determined, the porosity, that is, the filling rate of the proton conductive electrolyte resin is automatically determined.

The inventors found, while exploring the physical property of the embedment preventive layer, that when the porosity, the thickness, and the basis weight of the embedment preventive layer are adjusted, an output performance of the membrane electrode assembly may be improved. When these physical properties of the embedment preventive layer are varied, a water vapor exchange function and the proton conductivity of the embedment preventive layer can be adjusted, further, the transfer defect of the CNT to the embedment preventive layer can be prevented.

Table 2 shown below is a table in which the porosities of the embedment preventive layers that include a PTFE stretched porous film having the specific gravity of about 2.2 g/cm³ and have the basis weights in the range of 0.05 to 1.0 mg/cm² and the thicknesses in the range of 1 to 10 μm are summarized. Columns shown with a hyphen in the following Table 2 indicate that there is no pore because the basis weight is too high.

TABLE 2

| | | Basis weight (mg/cm²) | | | | | |
|---|---|---|---|---|---|---|---|
| | | 0.05 | 0.1 | 0.2 | 0.4 | 0.8 | 1.0 |
| Thickness | 1 | 77.3% | 54.5% | 9.1% | — | — | — |
| (μm) | 3 | 92.4% | 84.8% | 69.7% | 39.4% | — | — |
| | 5 | 95.5% | 90.9% | 81.8% | 63.6% | 27.3% | 9.1% |
| | 10 | 97.7% | 95.5% | 90.9% | 81.8% | 63.6% | 54.5% |

As described above, the porosities described in Table 2 correspond to the filling rates of the proton conductive electrolyte resin. Therefore, from the viewpoint of the proton conductivity, when a total volume of the embedment preventive layer is set to 100%, a volume of the proton conductive electrolyte resin, that is, the filling rate of the proton conductive electrolyte resin is preferably 10 to 90% by volume. In this case, also the porosity of the embedment preventive layer is 10 to 90% by volume. When the filling rate is less than 10% by volume (that is, when the porosity of the embedment preventive layer is less than 10% by volume), a trouble may be caused in the proton conductivity between the electrolyte membrane and the conductive nano columnar bodies. On the other hand, when the filling rate exceeds 90% by volume (, that is, when the porosity of the embedment preventive layer exceeds 90% by volume), as a result of the trade-off of the improvement in the proton conductivity, the mechanical strength of the embedment preventive layer may be inferior.

The porosity of the embedment preventive layer is preferably 50% by volume or more and more preferably 60% by volume or more.

As obvious from Table 2 shown above, when at least the PTFE stretched porous film is used, it is preferable that the basis weight is 0.05 to 1.0 mg/cm² and the thickness is 1 to 10 μm from the viewpoint of the mechanical strength. When the basis weight of the embedment preventive layer is less than 0.05 mg/cm² or the thickness thereof is less than 1 μm, since the mechanical strength is too weak, during transfer, the conductive nano columnar body may penetrate through the embedment preventive layer and may be embedded in the electrolyte membrane. On the other hand, when the basis weight of the embedment preventive layer exceeds 1.0 mg/cm², adhesiveness of an interface between the embedment preventive layer and the conductive nano columnar body may be degraded. Further, when the thickness of the embedment preventive layer exceeds 10 μm, a trouble of the proton conductivity between the electrolyte membrane and the conductive nano columnar body may be caused.

A product of the thickness of the embedment preventive layer and the basis weight of the embedment preventive layer (hereinafter, referred to as a value of thickness×basis weight of the embedment preventive layer, in some cases) is preferably 1.8×10⁻⁴ mg/cm or less. The value of thickness of × basis weight of the embedment preventive layer is one measure of the proton conductivity of the embedment preventive layer, and the smaller the value is, the more excellent the proton conductivity is. That is, when the basis weights of the embedment preventive layers are the same, the thinner the thickness of the embedment preventive layer is, the more excellent the proton conductivity is. Further, when the thicknesses of the embedment preventive layers are the same, the smaller the basis weight of the embedment preventive layer is, the more excellent the proton conductivity is. When the value of thickness×basis weight of the embedment preventive layer exceeds 1.8×10⁻⁴ mg/cm, the proton conductivity of the embedment preventive layer is inferior and an output performance of the membrane electrode assembly may be degraded.

The value of thickness×basis weight of the embedment preventive layer is more preferably 1.2×10⁻⁴ mg/cm or less and still more preferably 1.0×10⁻⁴ mg/cm or less. Further the value of thickness×basis weight of the embedment preventive layer may be 0.5×10⁻⁵ mg/cm or more and may be 1.0×10⁻⁵ mg/cm or more.

In the present invention, it is preferable that the porosity of the embedment preventive layer is 50% or more and the value of thickness×basis weight of the embedment preventive layer is 1.8×10⁻⁴ mg/cm or less.

In Table 3 shown below, the physical properties when the thickness and the basis weight of the embedment preventive layer are determined are shown in 5 grades. A thick frame portion shows the physical properties of the embedment preventive layers used in Example 1 to Example 6 and Reference Example 1 to Reference Example 3.

Meanings of the respective marks are as shown below.

Double circle: The porosity is in the range of 60% or more and less than 80%.

Circle: The porosity is in the range of 80% or more and 99% or less.

Square: The porosity is in the range of 50% or more and less than 60%.

White triangle: The value of thickness×basis weight of the embedment preventive layer is in the range of 1.8×10⁻⁴ mg/cm or more.

Black triangle: The porosity is in the range of 0% or more and 50% or less.

TABLE 3

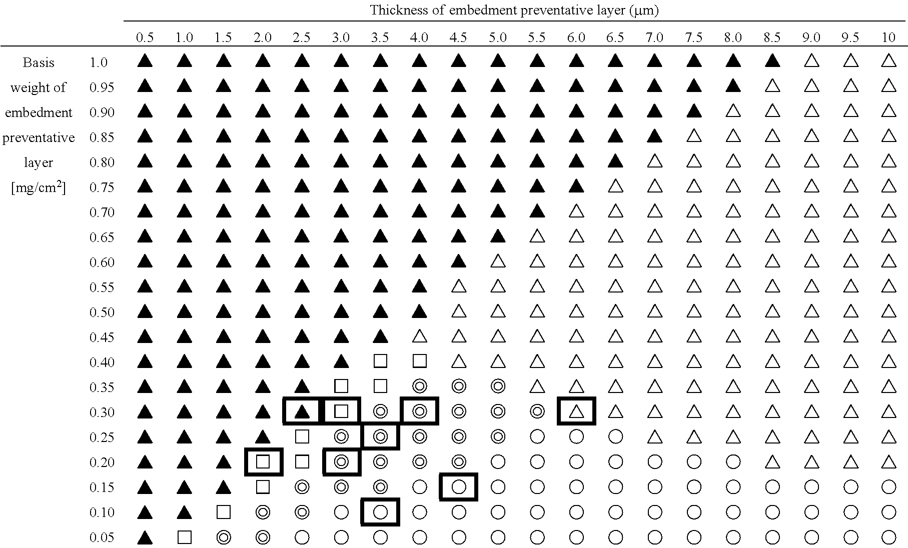

As shown in examples described below, when the porosity of the embedment preventive layer is set within the range of 50% or more and less than 60% (Example 2 to Example 3, square marks in Table 3), it was found that the output performance can be maintained at a high level such that the current density at 0.6 V is 1.9 mA/cm² or more. This is considered because when the porosity of the embedment preventive layer is set as low as possible and the value of thickness×basis weight of the embedment preventive layer is set to a small value, the proton conductivity in the embedment preventive layer can be improved. However, when the porosity of the embedment preventive layer is set in the range of 50% or more and less than 60%, since the porosity is low, the water vapor exchange capacity between electrodes may be degraded.

As shown in examples described below, when the porosity of the embedment preventive layer is set within the range of 80% or more and 99% or less (Reference Example 2 to Reference Example 3, circle marks in Table 3), it was found that the output performance can be maintained at a high level such that the current density at 0.6 V is 2.1 mA/cm² or more. This is considered because when the porosity of the embedment preventive layer is set as high as possible, the water vapor exchange capacity between electrodes can be improved. However, when the porosity of the embedment preventive layer is set in the range of 80% or more and 99% or less, since the porosity is high, a preventing effect for preventing the CNT from being embedded in the electrolyte membrane may be lowered.

As shown in examples described below, when the porosity of the embedment preventive layer is set within the range of 60% or more and less than 80% (Example 4 to Example 6, double circle marks in Table 3), it was found that the output performance can be maintained at a higher level such that the current density at 0.6 V is 2.3 mA/cm² or more. This is considered that because the porosity of the embedment preventive layer is properly high, the embedment preventive layer can prevent the CNT from being embedded in the electrolyte membrane, and all of an effect of capable of reducing an amount of the electrode catalyst embedded in the electrolyte membrane, an effect of capable of maintaining the water vapor exchange capacity between the electrodes at a high level, and an effect of excellently transferring the CNT can be satisfied.

When the porosity of the embedment preventive layer is set within the range of 60% or more and less than 80%, by enhancing the proton conductivity of the electrolyte membrane, the output performance can be further improved.

As shown in an example described below, when the porosity is set within the range of 0 or more and 50% or less (Reference Example 1, black triangle marks in Table 3), a slight unevenness in the transfer of the CNT in the embedment preventive layer may be generated.

Further, as shown in an example described below, when the value of thickness×basis weight of the embedment preventive layer is 1.8×10⁻⁴ mg/cm or more (Example 1, white triangle marks in Table 3), the proton conductivity may be inferior in some cases.

2. Electrode with Conductive Nano Columnar Body and Catalyst

The conductive nano columnar body used in the present invention is a columnar body having a nano-order column diameter, and, when a potential difference is applied between both ends of the columnar body, an electric current can be brought into conduction. The conductive nano columnar body is necessary to be oriented in a nearly vertical direction to a surface direction of the electrolyte membrane.

As the conductive nano columnar body used in the present invention, a CNT that is a representative material of the conductive nano columnar body is preferably used. This is because since the electrical resistance of the CNT is low, the loss of electrons can be suppressed compared with the case where the catalyst is supported on carbonaceous particles such as carbon black.

A shape such as a tube diameter and a tube length of the CNT is not particularly limited. However, from the viewpoint of a catalyst amount that can be supported, the tube length is preferably 10 to 200 μm. When the tube length is shorter than 10 μm, the catalyst amount that can be supported becomes slight. On the other hand, when the tube length is longer than 200 μm, the gas diffusion may be disturbed.

Further, a structure of the CNT may be a single layer CNT obtained by rounding one graphene sheet, or a multi-layered CNT obtained by stacking a plurality of graphene sheets in a nesting manner.

Further, as the conductive nano columnar body other than the CNT, as long as it is a slender conductive material having a column diameter of about 1 to 50 nm, a length of about 10 to 200 μm, and an aspect ratio of about 200 to 200,000, it is not particularly limited, for example, a carbon nano fiber can be used.

As the catalyst that is supported by the conductive nano columnar body, as long as it has a catalytic action in an oxidizing reaction of hydrogen in an anode or a reducing reaction of oxygen in a cathode, anyone can be used. For example, metals such as platinum, ruthenium, iridium, rhodium, palladium, osmium, tungsten, lead, iron, chromium, cobalt, nickel, manganese, vanadium, molybdenum, gallium, and aluminum, or alloys thereof can be used. Preferably, platinum, and alloys formed of platinum and other metal such as ruthenium can be used.

The catalyst is preferably a particle having a particle size smaller than a column diameter of the conductive nano columnar body, specifically, a particle size of 1 to 10 nm, particularly, a particle size of 2 to 6 nm is preferable.

In the present invention, the conductive nano columnar body is not embedded in the electrolyte membrane. Therefore, in order to secure the proton conductivity of a joining portion of the conductive nano columnar body and the electrolyte membrane, one end of the conductive nano columnar body is brought into contact with the electrolyte membrane, or, in the case of non-contact, for example, when a preventive layer for preventing conductive nano columnar bodies from being embedded described below is disposed in an interface between the conductive nano columnar body and the electrolyte membrane, a thickness of the preventive layer for preventing conductive nano columnar bodies from being embedded is set to 500 nm to 10 μm, and, the preventive layer for preventing conductive nano columnar bodies from being embedded is preferable to have sufficient proton conductivity.

A distance between the conductive nano columnar bodied is preferably 50 to 300 nm. When the distance is less than 50 nm, sufficient gas diffusivity as an electrode for a fuel cell cannot be ensured. Further, when the distance exceeds 300 nm, a unit area cannot have a sufficient number of conductive nano columnar bodied in the electrode, thus a transfer of protons between the electrolyte membrane and the electrode does not efficiently occur.

The conductive nano columnar body on which the catalyst used in the present invention is supported is preferably further coated with an electrolyte resin. As the electrolyte resin that can be preferably used in the present invention, the electrolyte resins generally used in the fuel cell can be used. For example, the electrolyte resins used for the electrolyte membrane described above can be used.

A coating amount of the electrolyte resin on the conductive nano columnar body is not particularly limited and can be properly determined by considering the proton conductivity and the gas diffusivity of the electrode. Usually, a weight ratio of the electrolyte resin to the conductive nano columnar bodies (mass of the electrolyte resin/mass of the conductive nano columnar bodies) is preferably in the range of about 1 to 5 and particularly preferably in the range of 2 to 3. When the mass ratio of the electrolyte resin with respect to the conductive nano columnar bodies is excessively large, although the proton conductivity becomes higher, the gas diffusivity tends to decrease. On the other hand, when the mass ratio of the electrolyte resin to the conductive nano columnar bodies is excessively small, although the gas diffusivity becomes higher, the proton conductivity tends to decrease. At this time, a thickness of the electrolyte resin in a nearly vertical direction to a surface of the conductive nano columnar body is preferably 5 to 15 nm.

In the membrane electrode assembly of the present invention, such an electrode structure as described above may be provided to either one of the anode and the cathode, or both of the anode and cathode may have the structure as described above.

In the present invention, it is preferable that the cathode electrode includes the conductive nano columnar bodies. A reaction on the cathode side tends to be diffusion control of oxygen in particular. Therefore, it is particularly preferable to use the conductive nano columnar bodies, preferably the CNTs, on the cathode side. Further, although also the anode side may use a conventional electrode, when the conductive nano columnar bodies, preferably the CNTs are used, an effect of performance improvement, and an effect of reducing an amount of platinum more than ever can be expected. Further, when as a fuel, not pure hydrogen, but a denatured gas obtained by denaturing a hydrocarbon fuel is used, since a hydrogen concentration decreases and the possibility of becoming diffusion control of hydrogen becomes higher, it is more effective to use the conductive nano columnar bodies, preferably the CNTs, on the anode side.

Hereinafter, typical examples of the membrane electrode assemblies for a fuel cell according to the present invention will be described with reference to the drawings.

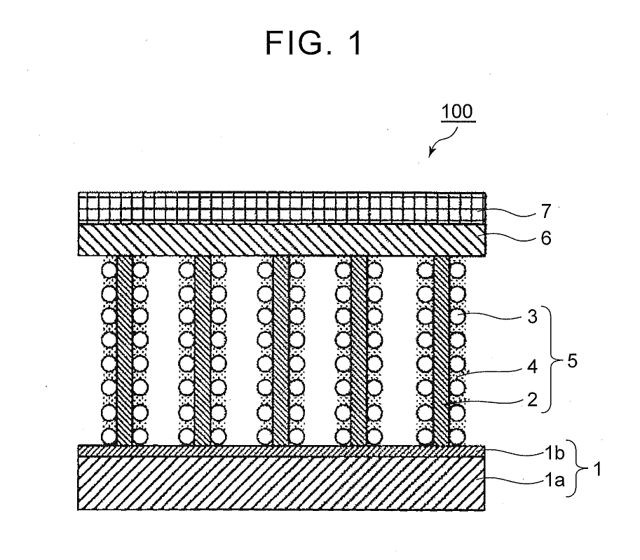

FIG. 1 is a diagram that shows a first typical example of the membrane electrode assembly for a fuel cell according to the present invention and schematically shows a cross-section cut in a stacking direction.

A first typical example 100 includes an electrolyte membrane 1, and an electrode formed of a catalyst layer 5, a porous layer 6 and a gas diffusion layer 7. The electrolyte membrane 1 includes one proton conductive layer la, and one preventive layer 1b for preventing conductive nano columnar bodies from being embedded, and the preventive layer 1b for preventing conductive nano columnar bodies from being embedded is disposed in an interface between the electrode and the electrolyte membrane 1. On the other hand, the proton conductive layer la is disposed on a side opposite to the electrode with the preventive layer 1b for preventing conductive nano columnar bodies from being embedded interposed therebetween. The catalyst layer 5 includes conductive nano columnar bodies 2 that are oriented in a nearly vertical direction with respect to a surface direction of the electrolyte membrane 1, a catalyst 3 supported by the conductive nano columnar body 2, and preferably an electrolyte resin 4 coated on the conductive nano columnar body 2.

Thus, when the preventive layer 1b for preventing conductive nano columnar bodies from being embedded is disposed on a surface of the electrolyte membrane 1, there is no risk of the conductive nano columnar bodies 2 being embedded in the electrolyte membrane 1.

On the side opposite to the electrode with the electrolyte membrane 1 sandwiched therebetween, a conventional electrode that uses spherical carbon may be disposed.

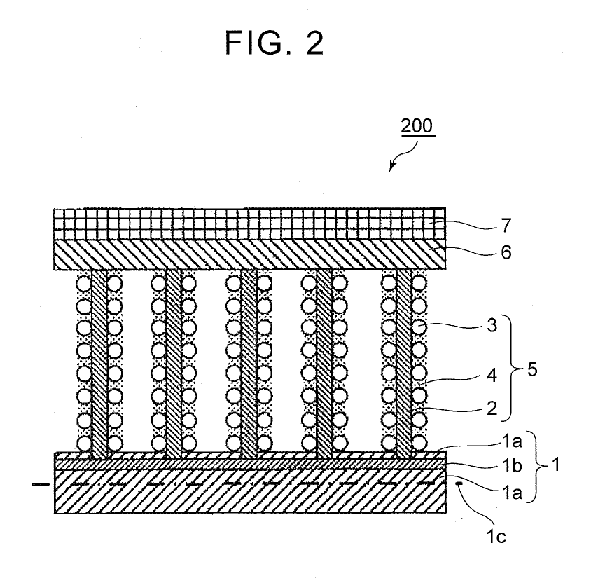

FIG. 2 is a diagram that shows a second typical example of the membrane electrode assembly for a fuel cell according to the present invention and schematically shows a cross-section cut in a stacking direction.

A second typical example 200 includes the electrolyte membrane 1, and the electrode formed of the catalyst layer 5, the porous layer 6 and the gas diffusion layer 7. The electrolyte membrane 1 includes two proton conductive layers 1a, and one preventive layer 1b for preventing conductive nano columnar bodies from being embedded, and the preventive layer 1b for preventing the conductive nano columnar bodies from being embedded is disposed in the inside of the electrolyte membrane 1 and between an interface between the electrode and the electrolyte membrane 1 and a center 1c of the electrolyte membrane in a thickness direction. On the other hand, the two proton conductive layers 1a occupy a portion other than a portion where the preventive layer 1b for preventing the conductive nano columnar bodies from being embedded is disposed in the electrolyte membrane 1. That is, one of the two proton conductive layers 1a is disposed between the preventive layer 1b for preventing the conductive nano columnar bodies from being embedded and the electrode and the other one is disposed on a side opposite to the electrode with the preventive layer 1b for preventing conductive nano columnar bodied from being embedded sandwiched therebetween. The catalyst layer 5 includes the conductive nano columnar bodies 2 that are oriented in a nearly vertical direction with respect to a surface direction of the electrolyte membrane 1, the catalyst 3 supported by the conductive nano columnar bodies 2, and preferably the electrolyte resin 4 coated on the conductive nano columnar bodies 2.

Thus, when the preventive layer 1b for preventing conductive nano columnar bodies from being embedded is disposed toward the electrode than a center of the electrolyte membrane in a thickness direction, there is no risk of the conductive nano columnar bodies 2 being embedded to a center 1c of the electrolyte membrane in a thickness direction.

Further, on a side opposite to the electrode with the electrolyte membrane 1 sandwiched, a conventional electrode that uses spherical carbon may be disposed.

The embedment preventive layer is preferably disposed in a portion having a thickness of 0 to 5 μm from an interface with the electrode toward a thickness direction of the electrolyte membrane. This is because when the embedment preventive layer is disposed in a thickness direction deeper than 5 μm, the conductive nano columnar body is embedded deeper, as a result, the catalyst may not be prevented from being embedded.

The physical properties necessary for the embedment preventive layer are not different between an aspect where the embedment preventive layer is disposed on an uppermost surface of the electrolyte membrane like the first typical example and an aspect where the embedment preventive layer is disposed in the inside of the electrolyte membrane like the second typical example, that is, the necessary physical properties are determined from the viewpoint of the mechanical strength and the proton conductivity as described above.

However, when a case where the membrane electrode assembly for a fuel cell according to the present invention is used for discharge under high temperature condition is assumed, from the viewpoint of increasing an amount of moisture in the inside of the electrolyte membrane to suppress drying of the electrolyte membrane, the aspect where the embedment preventive layer is disposed in the inside of the electrolyte membrane (second typical example) is preferable than the aspect where the embedment preventive layer is disposed on an uppermost surface of the electrolyte membrane (first typical example) because a content ratio of the proton conductive electrolyte resin contained in the embedment preventive layer is larger.

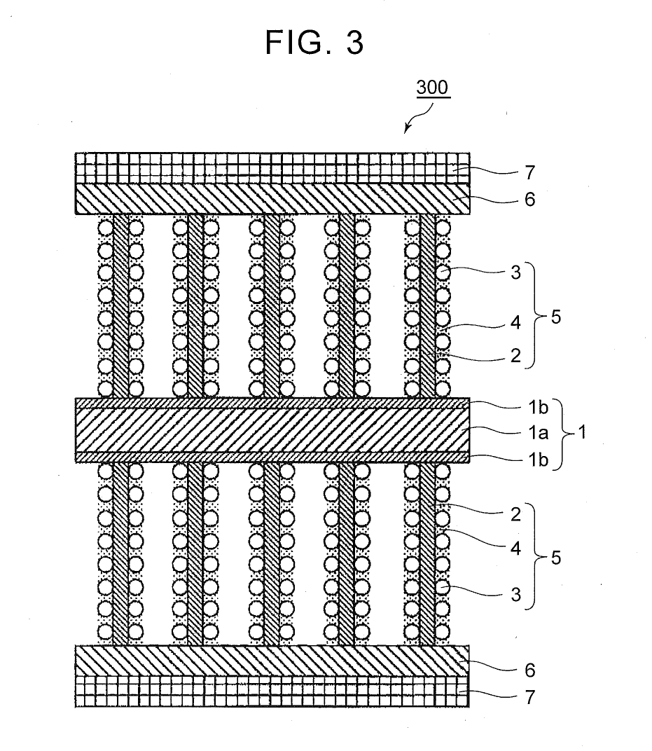

FIG. 3 is a diagram that shows a third typical example of the membrane electrode assembly for a fuel cell according to the present invention and schematically shows a cross-section cut in a stacking direction.

A third typical example 300 includes the electrolyte membrane 1, and two electrodes formed of the catalyst layer 5, the porous layer 6 and the gas diffusion layer 7. The electrolyte membrane 1 includes one proton conductive layer 1a, and two preventive layers 1b for preventing conductive nano columnar bodies from being embedded, and the two preventive layers 1b for preventing the conductive nano columnar bodies from being embedded are disposed in each of interfaces between the electrolyte membrane 1 and two electrodes. On the other hand, the proton conductive layer 1a is sandwiched between two preventive layers 1b for preventing conductive nano columnar bodies from being embedded. Each of the two catalyst layers 5 includes the conductive nano columnar bodies 2 that are oriented in a nearly vertical direction with respect to a surface direction of the electrolyte membrane 1, the catalyst 3 supported by the conductive nano columnar bodies 2, and preferably the electrolyte resin 4 coated on the conductive nano columnar bodies 2.

Thus, when the preventive layer 1b for preventing the conductive nano columnar bodies from being embedded is disposed on both surfaces of the electrolyte membrane 1, there is no risk of the conductive nano columnar bodies 2 being embedded in the electrolyte membrane 1.

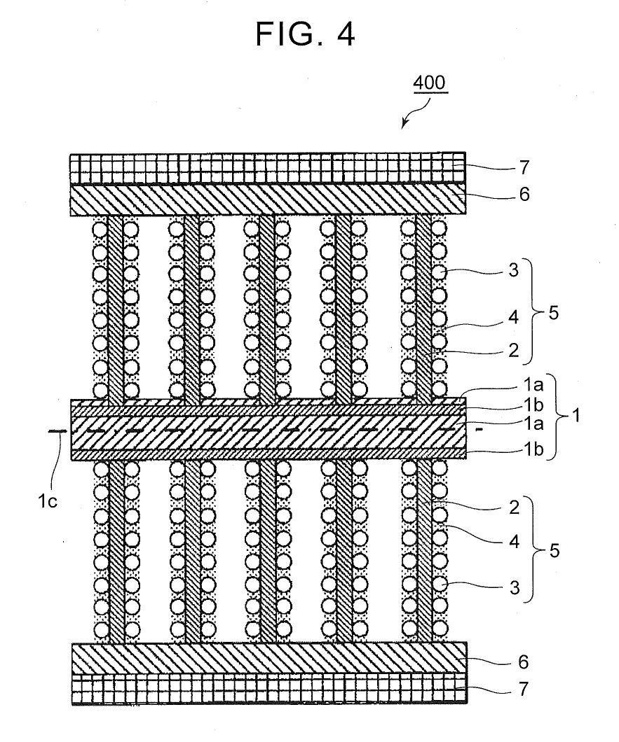

FIG. 4 is a diagram that shows a fourth typical example of the membrane electrode assembly for a fuel cell according to the present invention and schematically shows a cross-section cut in a stacking direction.

A fourth typical example 400 includes the electrolyte membrane 1, and two electrodes formed of the catalyst layer 5, the porous layer 6 and the gas diffusion layer 7. The electrolyte membrane 1 includes two proton conductive layers 1a, and two preventive layers 1b for preventing conductive nano columnar bodies from being embedded. One preventive layer 1b for preventing the conductive nano columnar bodies from being embedded is disposed in an interface between one electrode and the electrolyte membrane 1. The other preventive layer 1b for preventing the conductive nano columnar bodies from being embedded is disposed in the inside of the electrolyte membrane 1 and between an interface between the other electrode and the electrolyte membrane 1 and a center 1c of the electrolyte membrane 1 in a thickness direction. On the other hand, two proton conductive layers 1a occupy a portion other than a portion where two preventive layers 1b for preventing the conductive nano columnar bodies from being embedded are disposed in the electrolyte membranes 1. That is, one of the two proton conductive layers 1a is disposed between the other preventive layer 1b for preventing the conductive nano columnar bodies from being embedded and the electrode, and the other is sandwiched between two preventive layers 1b for preventing the conductive nano columnar bodies from being embedded. Each of two catalyst layers 5 includes the conductive nano columnar bodies 2 that are oriented in a nearly vertical direction with respect to a surface direction of the electrolyte membrane 1, the catalyst 3 supported by the conductive nano columnar bodies 2, and preferably the electrolyte resin 4 coated on the conductive nano columnar bodies 2.

Thus, when one of the preventive layers 1b for preventing the conductive nano columnar bodies from being embedded is disposed on a surface of the electrolyte membrane 1, and, the other of the preventive layers 1b for preventing the conductive nano columnar bodies from being embedded is disposed on the catalyst layer 5 side than the center 1c of the electrolyte membrane in the thickness direction, there is no risk of the conductive nano columnar bodies 2 being embedded at least to the center 1c of the electrolyte membrane in the thickness direction.

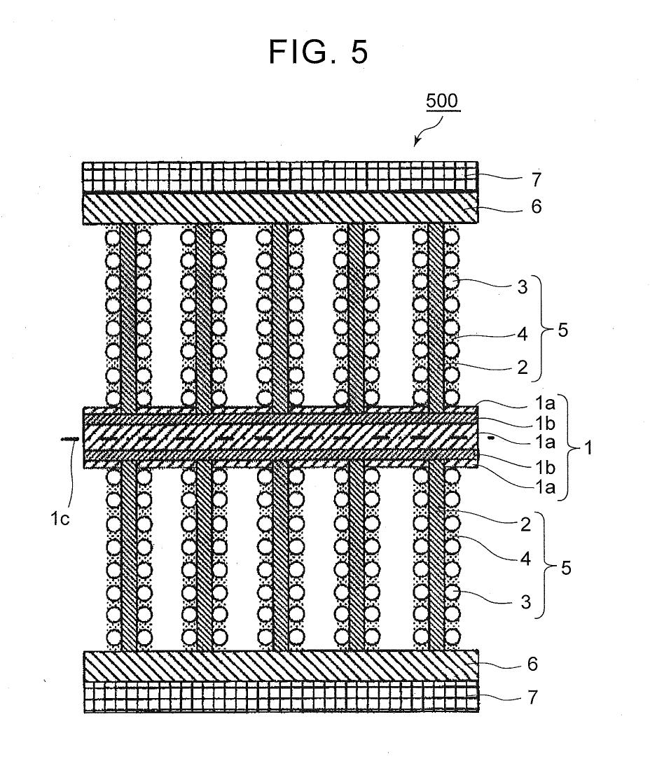

FIG. 5 is a diagram that shows a fifth typical example of the membrane electrode assembly for a fuel cell according to the present invention and schematically shows a cross-section cut in a stacking direction.

A fifth typical example 500 includes the electrolyte membrane 1, and two electrodes formed of the catalyst layer 5, the porous layer 6 and the gas diffusion layer 7. The electrolyte membrane 1 includes three proton conductive layers 1a, and two preventive layers 1b for preventing conductive nano columnar bodies from being embedded. One of the preventive layers 1b for preventing the conductive nano columnar bodies from being embedded is disposed in the inside of the electrolyte membrane 1 and between an interface between one electrode and the electrolyte membrane 1 and a center 1c of the electrolyte membrane 1 in a thickness direction. The other of the preventive layers 1b for preventing the conductive nano columnar bodies from being embedded is disposed in the inside of the electrolyte membrane 1 and between an interface between the other electrode and the electrolyte membrane 1 and a center 1c of the electrolyte membrane 1 in a thickness direction. On the other hand, the three proton conductive layers 1a occupy a portion other than a portion where two preventive layers 1b for preventing the conductive nano columnar bodies from being embedded are disposed in the electrolyte membrane 1. That is, two of the three proton conductive layers 1a are disposed in each of interfaces between the electrolyte membrane 1 and two electrodes and remaining one of the three proton conductive layers 1a is sandwiched between two preventive layers 1b for preventing the conductive nano columnar bodies from being embedded. Each of two catalyst layers 5 includes the conductive nano columnar bodies 2 that are oriented in a nearly vertical direction with respect to a surface direction of the electrolyte membrane 1, the catalyst 3 supported by the conductive nano columnar bodies 2, and preferably the electrolyte resin 4 coated on the conductive nano columnar bodies 2.

Thus, when both of the preventive layers 1b for preventing the conductive nano columnar bodies from being embedded are disposed on the catalyst layer 5 side than a center 1c of the electrolyte membrane in the thickness direction, there is no risk of the conductive nano columnar bodies 2 being embedded to the center 1c of the electrolyte membrane in the thickness direction.

The membrane electrode assembly for a fuel cell according to the present invention may include the porous layer and the gas diffusion layer sequentially on a side opposite to the electrolyte membrane with the catalyst layer containing conductive nano columnar bodies sandwiched therebetween.

The porous layer (water repellent layer) used in the present invention usually has a porous structure that contains conductive power particles such as carbon particles or carbon fibers, and a water repellent resin such as polytetrafluoroethylene (PTFE). The porous layer is not necessarily required. However, there is an advantage that the drainage performance of the gas diffusion layer can be enhanced while properly retaining an amount of moisture in the catalyst layer and electrolyte membrane, and, further, an electrical contact between the catalyst layer and the gas diffusion layer can be improved.

A method of manufacturing the porous layer on the gas diffusion layer is not particularly limited. For example, a water repellent ink obtained by mixing conductive powder particles such as carbon particles and a water repellent resin, and other components as required with a solvent such as an organic solvent such as ethanol, propanol, and propylene glycol, water or a mixture thereof may be coated on a side that faces at least the catalyst layer of the gas diffusion layer, and after that, may be dried and/or sintered. A thickness of the porous layer may usually be about 1 to 50 μm. As a method of coating a porous layer ink on the gas diffusion layer, for example, a screen printing method, a spray method, a doctor blade method, a gravure printing method, and a die coat method can be used.

As the gas diffusion layer that is used in the present invention, a gas diffusion sheet that has gas diffusivity capable of supplying a gas efficiently to the catalyst layer, electric conductivity, and the mechanical strength required as a material that forms the gas diffusion layer can be used. As the gas diffusion sheet, for example, conductive porous bodies such as carbonaceous porous bodies such as carbon paper, carbon cloth and carbon felt, metal meshes or metal porous bodies formed of a metal such as titanium, aluminum, nickel, nickel-chromium alloy, copper and alloys thereof, silver, aluminum alloys, zinc alloys, lead alloys, titanium, niobium, tantalum, iron, stainless, gold, and platinum can be used. A thickness of the conductive porous body is preferably about 50 to 500 μm.

Further, the gas diffusion layer may be processed such that moisture in the catalyst layer can be efficiently drained outside the gas diffusion layer by impregnating with the water repellent resin such as polytetrafluoroethylene on a side that faces the catalyst layer by coating with a bar coater and the like.

Hereinafter, a method of manufacturing the membrane electrode assembly for a fuel cell according to the present invention will be describe in more detail. A method of obtaining the membrane electrode assembly for a fuel cell according to the present invention is not limited to the methods described below.

Firstly, conductive nano columnar bodies are prepared by growing the conductive nano columnar bodies on a base material. As the conductive nano columnar bodies that are grown on the base material, the CNTs can be used.

For growing the CNTs, firstly, a base material that supports metal fine particles is prepared. As the base material, a silicon base material, a glass base material, and a quartz base material can be used. A surface of the base material is cleansed as required. As a cleansing method of the base material, for example, a heat treatment in vacuum is used. The base material is not particularly limited as long as a layer of the conductive nano columnar bodies can be evenly formed thereon, a plate or a sheet can be used.

Hereinafter, a case where the CNT is used as the conductive nano columnar body is mainly described.

The metal fine particle is a nucleus when the CNT grows, for example, iron, nickel, cobalt, manganese, molybdenum, and palladium can be used. When a solution containing these metals or metal complexes of these metals is coated or a metal thin film is formed on the base material by an electron beam deposition method, and is heated under an inert gas atmosphere or reduced pressure to about 700 to 750° C., the metal thin film is micronized and the metal fine particles can be supported on the base material. The metal fine particles are usually preferable to have a particle size of about 5 to 20 nm, and in order to make the metal fine particles having such a particle size support, a film thickness of the metal thin film is preferably set to about 3 to 10 nm.

Next, the CNT is grown on the base material. In the step of growing the CNT, with the base material that supports the metal fine particles disposed in a space of an inert gas atmosphere at a specified temperature (usually, about 700 to 750° C.) appropriate for growing the CNT, a raw material gas is supplied to the metal fine particles on the base material. As the raw material gas, for example, hydrocarbon-based gases such as acetylene, methane, and ethylene can be used.

A flow rate, a supply time, and a total supply amount of the raw material gas are not particularly limited and may be optionally determined by considering a tube length and a tube diameter of the CNT. For example, depending on a concentration [raw material gas flow rate/(raw material gas flow rate+inert gas flow rate)] of the raw material gas being supplied, a length of the CNT that grows is different. That is, the higher the concentration of the raw material gas being supplied is, the shorter a length of the CNT is.

Further, soot is generated during the growth of the CNT, and, when the soot is piled around the metal fine particles, the raw material gas supply to the metal fine particles may be disturbed. The growth of the CNT proceeds with the metal fine particles on the base material as a nucleus, therefore, it is considered that, when the raw material gas supply to the metal fine particles is disturbed, the growth of the CNT is stopped in a tube length direction, and the growth in a tube diameter direction will take place mainly.

It is preferable that a length of the CNT is 10 to 200 μm, a tube diameter is 1 to 50 nm, and a distance between the CNTs is 50 to 300 nm. This is because in the support of the catalyst described below, a sufficient amount of the catalyst can be supported on the CNT.

As described above, the CNTs nearly vertically oriented to a surface direction of the base material can be obtained on the base material. The CNTs nearly vertically oriented to a surface direction of the base material herein contain the CNTs of which a shape in a tube length direction is linear and/or not linear, when the shape in the tube length direction is linear, an angle of the straight line with the surface direction of the base material, in the case of the CNTs of which a shape in the tube length direction is not linear, an angle of a straight line that binds center portions of both end surfaces with the surface direction of the base material is nearly orthogonal.

The method of growing the CNT described above uses a CVD method (chemical vapor deposition method) that grows the CNTs by allowing co-existence of the metal fine particles (catalyst metal) and the raw material gas under high temperature condition. However, the method of growing the CNTs is not limited to the CVD method, for example, vapor deposition methods such as an arc discharge method and a laser deposition method, or other well-known synthesis methods can be used to grow.

A method of supporting the catalyst on the CNTs is not particularly limited. Either one of a wet method and a dry method can be used. As the wet method, a method where after a solution containing a metal salt is coated on a surface of the CNTs, the CNTs are heated at a temperature of 200° C. or more in a hydrogen atmosphere to reduce can be used. As the metal salt, halides of the metals, metal acid halides, inorganic acid salts of the metals, organic acid salts of the metals and metal complexes of the metals exemplified as the catalysts, can be used. A solution containing these metal salts may be an aqueous solution or an organic solvent solution. When a metal salt solution is coated on a surface of the CNTs, for example, a method of dipping the CNTs in the metal salt solution, or a method of dripping or spraying the metal salt solution on a surface of the CNTs can be used.

For example, when platinum is used as the catalyst, as the wet method, a platinum salt solution in which an adequate amount of chloroplatinic acid or a platinum nitrate solution (dinitrodiamine platinum nitrate solution, for example) is dissolved in alcohol such as ethanol or isopropanol can be used. From the viewpoint that platinum can be uniformly supported on a surface of the CNTs, in particular, a platinum salt solution in which a dinitrodiamine platinum nitrate solution is dissolved in alcohol is preferably used.

As the dry method, an electron beam deposition method, a sputtering method, and an electrostatic coating method can be used.

A method of coating the electrolyte resin on the CNTs that support the catalyst is not particularly limited. For example, other than a method of coating the electrolyte resin that is a polymer on the CNTs, a method of coating a polymerizing composition that contains an electrolyte resin precursor (a monomer that forms the electrolyte resin) and, as required, additives such as various kinds of polymerization initiators, on a CNT surface, as required, after drying, irradiating radiation such UV ray or heating to polymerize may be adopted.

A method of disposing the embedment preventive layer in the electrolyte membrane is not particularly limited.

Like the first or third typical example described above, when the embedment preventive layer is disposed on a surface of the electrolyte membrane, the embedment preventive layer may be stuck to one surface or both surfaces of the proton conductive layer.

Like the second, fourth or fifth typical example, when the embedment preventive layer is disposed in the inside of the electrolyte membrane, the embedment preventive layer optionally sandwiched with two or more proton conductive layers may be stuck. The embedment preventive layer may be formed by coating or spraying a raw material of the embedment preventive layer on one surface or both surfaces of the proton conductive layer. On the contrary, the proton conductive layer may be formed by coating or spraying a raw material of the proton conductive layer on one surface or both surfaces of the embedment preventive layer.

A method of transferring the CNTs on the electrolyte membrane is not particularly limited, that is, well-known methods can be used. As the transfer method, for example, a thermal transfer method and the like can be used. Hereinafter, the themial transfer method will be described.

A heating temperature in the thermal transfer is set to a softening temperature of the ionomer coated on the electrolyte membrane and the CNTs or more. However, it is preferable to avoid excessive heating such that degradation of the electrolyte membrane and the ionomer or a decrease in the proton conductivity may not be caused. Although a proper heating temperature of the thermal transfer is different depending on the electrolyte membrane or the electrolyte resin used, usually, it may be about 110 to 160° C., preferably about 140 to 150° C. When a perfluorocarbon sulfonic acid resin is used as the electrolyte membrane and the electrolyte resin, it is preferably set to 120 to 140° C.

A pressing force is usually about 2 to 12 MPa, preferably 4 to 8 MPa, when the heating temperature is in the range described above. When the perfluorocarbon sulfonic acid resin is used as the electrolyte membrane and the electrolyte resin, 8 to 10 MPa is preferable.

A time (transfer time) for holding the heating temperature and the pressing force described above is usually about 5 to 20 minutes, preferably about 10 to 15 minutes. When the perfluorocarbon sulfonic acid resin is used as the electrolyte membrane and the electrolyte resin, 10 to 15 minutes is preferable.

When a porous layer and/or a gas diffusion layer is disposed, the porous layer and/or the gas diffusion layer may be stacked further from above the catalyst layer.

### EXAMPLES

Hereinafter, the present invention will be further specifically described with reference to examples and comparative examples. However, the present invention is not limited to only these examples.

1. Preparation of Base Material with Nearly Vertically Oriented CNTs

### Manufacturing Example 1

First, on a silicon substrate, an iron catalyst as the catalyst metal was sputtered and deposited. The substrate on which the catalyst metal was deposited was placed inside a CVD furnace.

Next, a hydrogen 25% gas (carrier: nitrogen) was supplied into the CVD furnace, a temperature inside the furnace was raised from room temperature (15 to 25° C.) to 800° C. over 5 minutes to activate the catalyst metal.

Subsequently, into the CVD furnace, in addition to the hydrogen 25% gas (carrier: nitrogen), an acetylene 8% gas (carrier: nitrogen) as a carbon source was supplied, and the temperature inside the furnace was held at 800° C. for 10 minutes to grow the CNTs.

Finally, a nitrogen 100% gas was supplied into the CVD furnace, the temperature inside the furnace was lowered from 800° C. to room temperature (15 to 25° C.) over 5 minutes to stop the growth of the CNTs, thus, a base material with nearly vertically oriented CNTs of Manufacturing Example 1 was prepared.

2. Preparation of Base Material with Nearly Vertically Oriented CNTs on which Ionomer was Coated and Platinum was Supported

### Manufacturing Example 2

Firstly, a raw liquid of an ionomer solution was filtrated with a TEFLON (registered trade mark) filter and aggregated coarse ionomer particles were removed. Subsequently, an organic solvent was optionally added to the obtained filtrate to optionally dilute. The optionally diluted solution was subjected to ultrasonic treatment to highly disperse the ionomer in the solution, followed by centrifugal stirring, and an obtained supernatant was supplied as an ionomer solution to coat the CNTs.

After letting optionally support platinum on the base material with nearly vertically oriented CNTs of Manufacturing Example 1, the CNTs that support the catalyst were immersed in the ionomer solution. The nearly vertically oriented CNTs on which the ionomer was coated and platinum was supported (hereinafter, referred to as “ionomer-coated and platinum supporting CNTs”) was taken out, and, with a surface direction of the base material tilted in a direction the same as a vertical direction, was left under room temperature (15 to 25° C.). Subsequently, the ionomer-coated and platinum-supporting CNTs were dipped in ethanol. After the specified time elapsed, the ionomer-coated and platinum-supporting CNTs were taken out, and, with a surface direction of the base material tilted in a direction the same as a vertical direction, were left under room temperature (15 to 25° C.).

The ionomer-coated and platinum-supporting CNTs were, after taking out of the ionomer solution, depressurized in a reduced-pressure vessel, and optionally deaerated. After deaeration, the ionomer-coated and platinum-supporting CNTs were heated at 80° C. in the reduced pressure vessel and dried, thus, a base material with the ionomer-coated and platinum-supporting CNTs of Manufacturing Example 2 was prepared.

3. Manufacture of Membrane Electrode Assembly

### Example 1

The embedment preventive layer was prepared as shown below. Firstly, as the base material, a PTFE-stretched porous film was prepared. The stretched porous film was impregnated with the electrolyte resin (IEC 1.54 meq/g).

With a perfluorocarbon sulfonic acid electrolyte film (registered trade mark: Nafion) as a proton conductive layer, on both surfaces of the proton conductive layer, the PTFE-stretched porous film impregnated with the electrolyte resin was stuck, thus, the embedment preventive layer was formed on both surfaces of the proton conductive layer. A thickness of the embedment preventive layer was 6.0 μm, and the basis weight of the embedment preventive layer was 0.30 mg/cm². Therefore, a value of a product of thickness and basis weight (a value of thickness×basis weight of the embedment preventive layer) of the embedment preventive layer was 1.8×10⁻⁴ mg/cm. Further, from the thickness and the basis weight of the embedment preventive layer, the porosity of the embedment preventive layer was calculated as 77.3%.

From the base material with the ionomer-coated and platinum-supporting CNTs of the Manufacturing Example 2, the CNTs were transferred on the embedment preventive layer, thus, a membrane electrode assembly of Example 1 was manufactured. As the transfer condition, a temperature was set to 140° C., pressure was set to 10 MPa, and a transfer time was set to 30 minutes.

### Example 2

The embedment preventive layer was prepared as shown below. Firstly, as the base material, the PTFE-stretched porous film was prepared. The stretched porous film was impregnated with the electrolyte resin (IEC 1.54 meq/g). With the same proton conductive layer as that of Example 1, on both surfaces of the proton conductive layer, the PTFE-stretched porous film impregnated with the electrolyte resin was stuck, thus, the embedment preventive layer was formed on both surfaces of the proton conductive layer. A thickness of the embedment preventive layer was 3.0 μm, and the basis weight of the embedment preventive layer was 0.30 mg/cm². Therefore, a value of thickness×basis weight of the embedment preventive layer was 0.90×10⁻⁴ mg/cm. Further, from the thickness and the basis weight of the embedment preventive layer, the porosity of the embedment preventive layer was calculated as 54.5%.

After this, under the same transfer condition as that of Example 1, the CNTs were transferred on the embedment preventive layer from the base material with the ionomer-coated and platinum-supporting CNTs of the Manufacturing Example 2, thus, a membrane electrode assembly of Example 2 was manufactured.

### Example 3

The embedment preventive layer was prepared as shown below. Firstly, as the base material, the PTFE-stretched porous film was prepared. The stretched porous film was impregnated with the electrolyte resin (IEC 1.54 meq/g). With the same proton conductive layer as that of Example 1, on both surfaces of the proton conductive layer, the PTFE-stretched porous film impregnated with the electrolyte resin was stuck, thus, the embedment preventive layer was formed on both surfaces of the proton conductive layer. A thickness of the embedment preventive layer was 2.0 and the basis weight of the embedment preventive layer was 0.18 mg/cm². Therefore, a value of thickness×basis weight of the embedment preventive layer was 0.36×10⁻⁴ mg/cm. Further, from the thickness and the basis weight of the embedment preventive layer, the porosity of the embedment preventive layer was calculated as 59.1%.

After this, under the same transfer condition as that of Example 1, the CNTs were transferred on the embedment preventive layer from the base material with the ionomer-coated and platinum-supporting CNTs of the Manufacturing Example 2, thus, a membrane electrode assembly of Example 3 was manufactured.

### Example 4

The embedment preventive layer was prepared as shown below. Firstly, as the base material, the PTFE-stretched porous film was prepared. The stretched porous film was impregnated with the electrolyte resin (IEC 1.54 meq/g). With the same proton conductive layer as that of Example 1, on both surfaces of the proton conductive layer, the PTFE-stretched porous film impregnated with the electrolyte resin was stuck, thus, the embedment preventive layer was formed on both surfaces of the proton conductive layer. A thickness of the embedment preventive layer was 4.0 μm, and the basis weight of the embedment preventive layer was 0.30 mg/cm². Therefore, a value of thickness×basis weight of the embedment preventive layer was 1.2×10⁻⁴ mg/cm. Further, from the thickness and the basis weight of the embedment preventive layer, the porosity of the embedment preventive layer was calculated as 65.9%.

After this, under the same transfer condition as that of Example 1, the CNTs were transferred on the embedment preventive layer from the base material with the ionomer-coated and platinum-supporting CNTs of the Manufacturing Example 2, thus, a membrane electrode assembly of Example 4 was manufactured.

### Example 5

The embedment preventive layer was prepared as shown below. Firstly, as the base material, the PTFE-stretched porous film was prepared. The stretched porous film was impregnated with the electrolyte resin (IEC 1.54 meq/g). With the same proton conductive layer as that of Example 1, on both surfaces of the proton conductive layer, the PTFE-stretched porous film impregnated with the electrolyte resin was stuck, thus, the embedment preventive layer was formed on both surfaces of the proton conductive layer. A thickness of the embedment preventive layer was 3.25 μm, and the basis weight of the embedment preventive layer was 0.225 mg/cm². Therefore, a value of thickness×basis weight of the embedment preventive layer was 0.73×10⁻⁴ mg/cm. Further, from the thickness and the basis weight of the embedment preventive layer, the porosity of the embedment preventive layer was calculated as 68.5%.

After this, under the same transfer condition as that of Example 1, the CNTs were transferred on the embedment preventive layer from the base material with the ionomer-coated and platinum-supporting CNTs of the Manufacturing Example 2, thus, a membrane electrode assembly of Example 5 was manufactured.

### Example 6

The embedment preventive layer was prepared as shown below. Firstly, as the base material, the PTFE-stretched porous film was prepared. The stretched porous film was impregnated with the electrolyte resin (IEC 1.54 meq/g). With the same proton conductive layer as that of Example 1, on both surfaces of the proton conductive layer, the PTFE-stretched porous film impregnated with the electrolyte resin was stuck, thus, the embedment preventive layer was formed on both surfaces of the proton conductive layer. A thickness of the embedment preventive layer was 3.0 μm, and the basis weight of the embedment preventive layer was 0.20 mg/cm². Therefore, a value of the thickness×the basis weight of the embedment preventive layer was 0.60×10⁻⁴ mg/cm. Further, from the thickness and the basis weight of the embedment preventive layer, the porosity of the embedment preventive layer was calculated as 69.7%.

After that, under the same transfer condition as that of Example 1, the CNTs were transferred on the embedment preventive layer from the base material with the ionomer-coated and platinum-supporting CNTs of the Manufacturing Example 2, thus, a membrane electrode assembly of Example 6 was manufactured.

### Reference Example 1

The embedment preventive layer was prepared as shown below. Firstly, as the base material, the PTFE-stretched porous film was prepared. The stretched porous film was impregnated with the electrolyte resin (IEC 1.54 meq/g). With the same proton conductive layer as that of Example 1, on both surfaces of the proton conductive layer, the PTFE-stretched porous film impregnated with the electrolyte resin was stuck, thus, the embedment preventive layer was formed on both surfaces of the proton conductive layer. A thickness of the embedment preventive layer was 2.5 μm, and the basis weight of the embedment preventive layer was 0.30 mg/cm². Therefore, a value of thickness×basis weight of the embedment preventive layer was 0.75×10⁴ mg/cm. Further, from the thickness and the basis weight of the embedment preventive layer, the porosity of the embedment preventive layer was calculated as 45.5%.

After this, under the same transfer condition as that of Example 1, the CNTs were transferred on the embedment preventive layer from the base material with the ionomer-coated and platinum-supporting CNTs of the Manufacturing Example 2, thus, a membrane electrode assembly of Reference Example 1 was manufactured. In Reference Example 1, there was a slight irregularity when the CNTs were transferred on the embedment preventive layer.

### Reference Example 2

The embedment preventive layer was prepared as shown below. Firstly, as the base material, the PTFE-stretched porous film was prepared. The stretched porous film was impregnated with the electrolyte resin (IEC 1.54 meq/g). With the same proton conductive layer as that of Example 1, on both surfaces of the proton conductive layer, the PTFE-stretched porous film impregnated with the electrolyte resin was stuck, thus, the embedment preventive layer was formed on both surfaces of the proton conductive layer. A thickness of the embedment preventive layer was 3.25 μm, and the basis weight of the embedment preventive layer was 0.10 mg/cm². Therefore, a value of thickness×basis weight of the embedment preventive layer was 0.33×10⁴ mg/cm. Further, from the thickness and the basis weight of the embedment preventive layer, the porosity of the embedment preventive layer was calculated as 86.0%.

After this, under the same transfer condition as that of Example 1, the CNTs were transferred on the embedment preventive layer from the base material with the ionomer-coated and platinum-supporting CNTs of the Manufacturing Example 2, thus, a membrane electrode assembly of Reference Example 2 was manufactured.

### Reference Example 3

The embedment preventive layer was prepared as shown below. Firstly, as the base material, the PTFE-stretched porous film was prepared. The stretched porous film was impregnated with the electrolyte resin (IEC 1.54 meq/g). With the same proton conductive layer as that of Example 1, on both surfaces of the proton conductive layer, the PTFE-stretched porous film impregnated with the electrolyte resin was stuck, thus, the embedment preventive layer was formed on both surfaces of the proton conductive layer. A thickness of the embedment preventive layer was 4.25 μm, and the basis weight of the embedment preventive layer was 0.125 mg/cm². Therefore, a value of thickness×basis weight of the embedment preventive layer was 0.53×10⁻⁴ mg/cm. Further, from the thickness and the basis weight of the embedment preventive layer, the porosity of the embedment preventive layer was calculated as 86.6%.

After this, under the same transfer condition as that of Example 1, the CNTs were transferred on the embedment preventive layer from the base material with the ionomer-coated and platinum-supporting CNTs of the Manufacturing Example 2, thus, a membrane electrode assembly of Reference Example 3 was manufactured.

### Comparative Example 1

As the proton conductive layer of the electrolyte membrane, the same one as that of Example 1 was used.

The CNTs were transferred on both surfaces of the electrolyte membrane from the base material with the ionomer-coated and platinum-supporting CNTs of the Manufacturing Example 2, thus, a membrane electrode assembly of Comparative Example 1 was manufactured. The transfer condition and the transfer time were the same as that of Example 1.

That is, in the electrolyte membrane of Comparative Example 1, the electrolyte membrane without the embedment preventive layer was used.

4. Evaluation of Membrane Electrode Assembly

4-1. SEM Observation of Cross-section of Membrane Electrode Assembly

A SEM observation was performed on cross-sections of the membrane electrode assemblies of Example 6 and Comparative Example 1. A SEM observation condition was as follows. That is, the SEM observation was performed with a scanning electron microscope (S-5500 manufactured by Hitachi Limited) at an acceleration voltage of 5 kV and a magnification of about 1500 times.

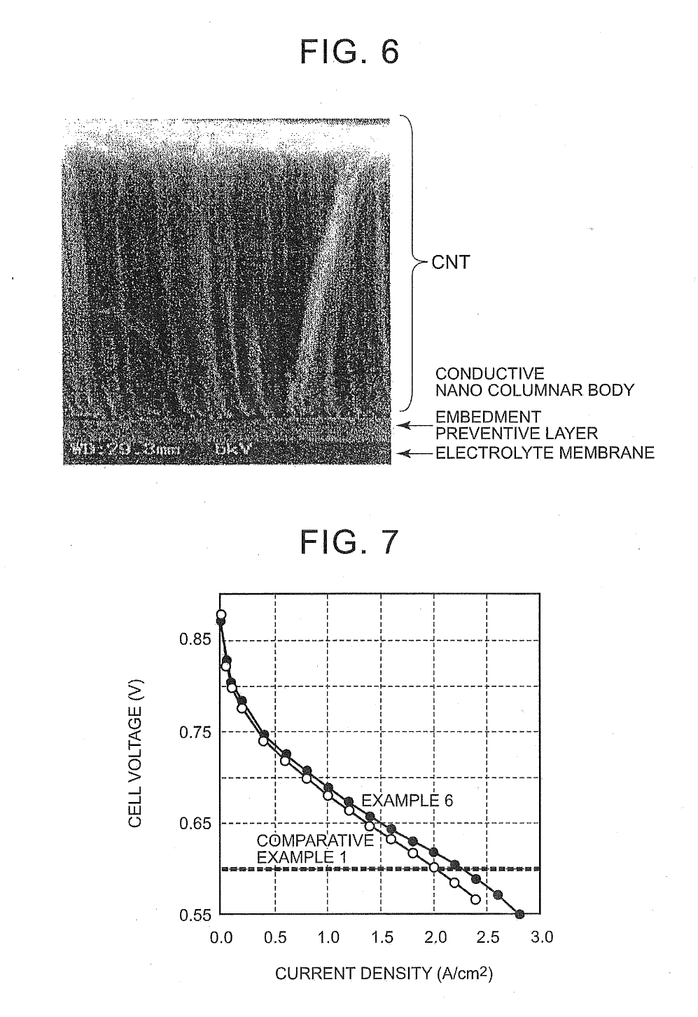

FIG. 6 shows a SEM image of a cross-section cut along a stacking direction of the membrane electrode assembly of Example 6. It can be confirmed from FIG. 6 that in the membrane electrode assembly of Example 6, the embedment preventive layer is disposed on a surface of the electrolyte membrane. Further, it was confirmed from FIG. 6 that an interface between the embedment preventive layer and the CNT is nearly flat. Therefore, in the interface like this, the CNT is not embedded in the electrolyte membrane. Further, by considering from the porosity (69.7% when the thickness is 3 μm, and the basis weight is 0.2 g/cm²) of Table 2 shown above, it is neither considered that a part of the CNT is embedded in the embedment preventive layer. From what was described above, it is suggested that in Example 6, since the CNT can be prevented from being embedded in the electrolyte membrane, also platinum fine particles are not embedded in the electrolyte membrane, as a result, a utilization rate of the platinum catalyst is improved.

On the other hand, it was confirmed that an interface between the electrolyte membrane and the CNT is wavy in a SEM image of a cross-section cut in a stacking direction of the membrane electrode assembly of Comparative Example 1. Therefore, in the interface like this, it is suggested that a part of the CNTs is embedded in the electrolyte membrane and a part of platinum catalyst particles is embedded in the electrolyte membrane, as a result, the utilization rate of the platinum catalyst is degraded.

4-2. Evaluation of Power Generation Performance of Membrane Electrode Assembly

The membrane electrode assemblies of Example 6 and Comparative Example 1 (Pt amount: 0.1 mg/cm²) were cut into strips having an area of 20 cm², and power generation performance thereof were evaluated. The evaluation condition was as follows.

Evaluation device: Water balance analyzer (manufactured by TOYO Corporation)

Humidification condition: No humidification condition on both of anode and cathode

Measurement temperature: 70° C.

Measurement potential: 0.2 to 1.0 V

Measurement current density: 0 to 3.0 A/cm²

FIG. 7 shows discharge curves of the membrane electrode assemblies of Example 6 and Comparative Example 1. FIG. 7 is a graph in which a vertical axis and a horizontal axis respectively show a cell voltage (V) and a current density (A/cm²). In FIG. 7, a black plot shows data of Example 6 and a white plot shows data of Comparative Example 1.

As obvious from FIG. 7, a difference of voltages of Example 6 and Comparative Example 1 was confirmed from a so-called low-load current region in the range of 0 to 0.5 A/cm². For example, while a voltage of Comparative Example 1 at 0.25 A/cm² is 0.776 V, a voltage of Example 6 at 0.25 A/cm² is 0.784 V. Thus, it is found that there is a voltage difference of 8 mV at 0.25 A/cm² between Example 6 and Comparative Example 1. A performance difference like this in the low load current region indicates a difference in the platinum utilization rates. That is, that the voltage at 0.25 A/cm² of Example 6 is higher by 8 mV than the voltage at 0.25 A/cm² of Comparative Example 1 shows that the platinum utilization rate of Example 6 is 1.3 times the platinum utilization rate of Comparative Example 1.

Further, the membrane electrode assembly of Example 6 showed such high current density as 2.3 A/cm² at 0.6 V.

From what was described above, it was verified that an amount of platinum that was embedded in the electrolyte membrane was reduced in the membrane electrode assembly of Example 6 where the embedment preventive layer was disposed compared with Comparative Example 1 where the embedment preventive layer was not disposed.

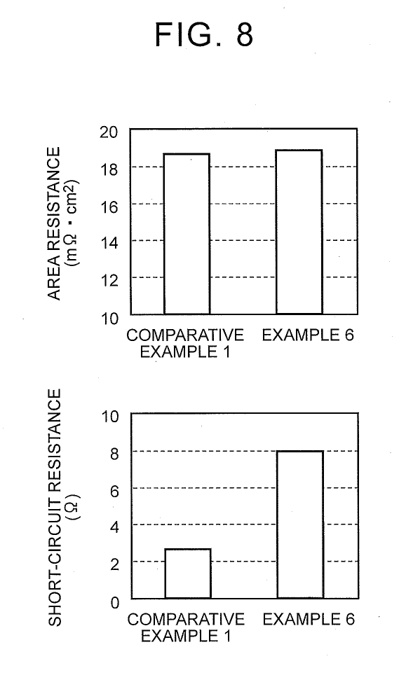

FIG. 8A is a bar graph in which area resistances (m∩·cm²) of Example 6 and Comparative Example 1 are compared. From FIG. 8A, while the area resistance of Comparative Example 1 is 18.4 mΩ·cm², the area resistance of Example 6 was 18.6 mΩ·cm², that is, there is hardly a difference between the area resistances of both data. Therefore, it is found in Example 6 that degradation of the adhesiveness in an interface between the embedment preventive layer and the CNT, which is considered as the tradeoff of an effect of a decrease in an amount of embedded platinum is not generated.

FIG. 8B is a bar graph in which short-circuit resistances (Ω) of Example 6 and Comparative Example 1 are compared. From FIG. 8B, it is found that while the short-circuit resistance of Comparative Example 1 is 2.6Ω, the short-circuit resistance of Example 6 is 8.1Ω. Therefore, since the short-circuit resistance of Example 6 is three times the short-circuit resistance of Comparative Example 1, it could be confirmed that the discharge efficiency of Example 6 is superior to the discharge efficiency of Comparative Example 1.

From what was described above, it is found that while, in the conventional membrane electrode assembly that uses the CNTs (Comparative Example 1), the power generation performance is inferior because a part of platinum particles is embedded in the electrolyte membrane, in the membrane electrode assembly of the present invention (Example 6) that uses the CNTs and the embedment preventive layer in combination, since the platinum particles are not embedded in the electrolyte membrane, excellent discharge performance is shown, and neither the adhesiveness of an interface of the embedment preventive layer and the CNTs is degraded. Further, the result of Example 6 is considered to correspond to a champion performance of the membrane electrode assembly that uses the catalyst layer in which an amount of platinum is 0.1 mg/cm².

The membrane electrode assemblies (Pt amount: 0.1 mg/cm²) of Example 1 to Example 6 and Reference Example 1 to Reference Example 3 were cut into strips having an area of 20 cm², and the strips were supplied to evaluate the power generation performance. The evaluation condition is as follows.

Evaluation device: Water balance analyzer (manufactured by TOYO Corporation)

Humidification condition of anode: Dew point of anode: 45° C.

Humidification condition of cathode: No humidification

Measurement temperature: 70° C.

Anode gas amount (anode stoichiometric ratio): 1.2

Cathode gas amount (cathode stoichiometric ratio): 1.5

Measurement potential: 0.2 to 1.0 V

Measurement current density: 0 to 3.0 A/cm²

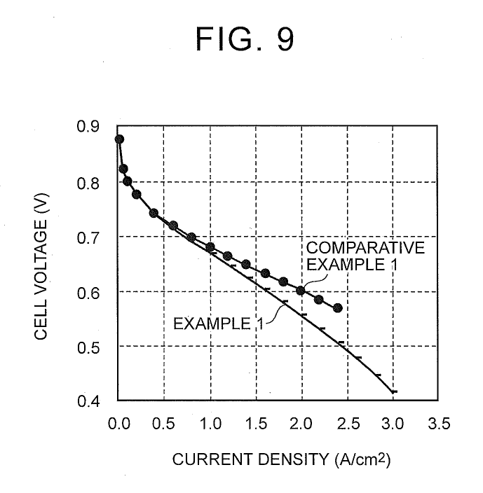

FIG. 9 shows discharge curves of the membrane electrode assemblies of Example 1 and Comparative Example 1. The vertical axis and the horizontal axis of FIG. 9 are the same as FIG. 7. In FIG. 9, a plot with crossbars and a plot with black circles, respectively show data of Example 1 and data of Comparative Example 1. As obvious from FIG. 9, the membrane electrode assembly of Example 1 denoted a voltage lower than that of the membrane electrode assembly of Comparative Example 1 in a so-called high load current region in the range of 0.5 A/cm² or more. Further, from FIG. 9, the current density of Example 1 at 0.6 V is 1.6 mA/cm².

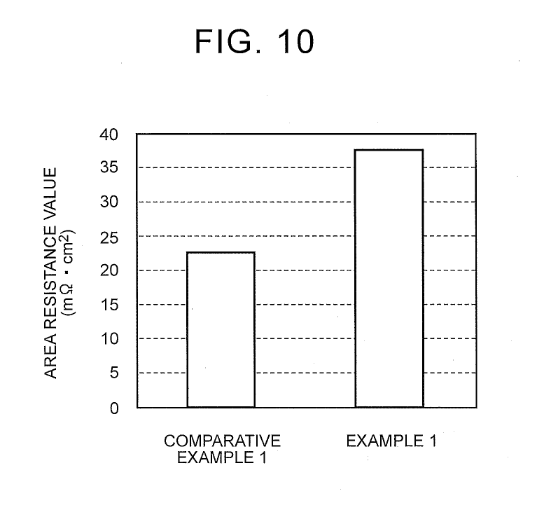

FIG. 10 is a bar graph in which the area resistances of the membrane electrode assemblies of Example 1 and Comparative Example 1 at the current density of 2.0 A/cm² are compared. As obvious from FIG. 10, while a value of the area resistance of the membrane electrode assembly of Example 1 is 37.5 mΩ·cm², the value of the area resistance of the membrane electrode assembly of Comparative Example 1 is 22.5 mΩ·cm².

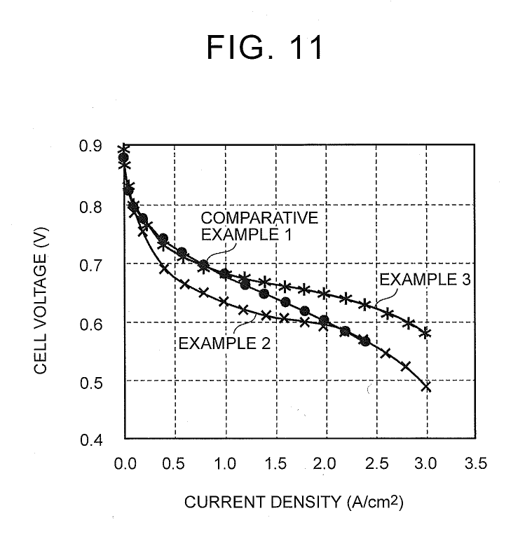

FIG. 11 shows discharge curves of the membrane electrode assemblies of Example 2, Example 3, and Comparative Example 1. The vertical axis and the horizontal axis in FIG. 11 are the same as FIG. 7. In FIG. 11, a plot with x marks, a plot with * marks, and a plot with black circles, respectively, show data of Example 2, data of Example 3, and data of Comparative Example 1.

As obvious from FIG. 11, in the so-called high load current region in the range of 2.0 A/cm² or more, Example 3 had a cell voltage higher than that of Comparative Example 1, and Example 2 had the cell voltage the same as that of Comparative Example 1. As obvious from FIG. 11, in the so-called low load current region in the range of 0 to 0.5 A/cm², the cell voltages of Example 2 and Example 3 were slightly lower than the cell voltage of Comparative Example 1. These results show that although the CNTs could be prevented from being embedded in the electrolyte membrane in the membrane electrode assemblies of Example 2 and Example 3, since the porosity of the embedment preventive layers were low, the water vapor exchange capacity was slightly low. However, in the membrane electrode assemblies of Example 2 and Example 3, since a function of the embedment preventive layer was exerted and the CNTs were prevented from being embedded in the electrolyte membrane, performance is supposed to be improved.

Further, from FIG. 11, the current density at 0.6 V of Example 2 is 1.9 mA/cm², and the current density at 0.6 V of Example 3 is 2.8 mA/cm².

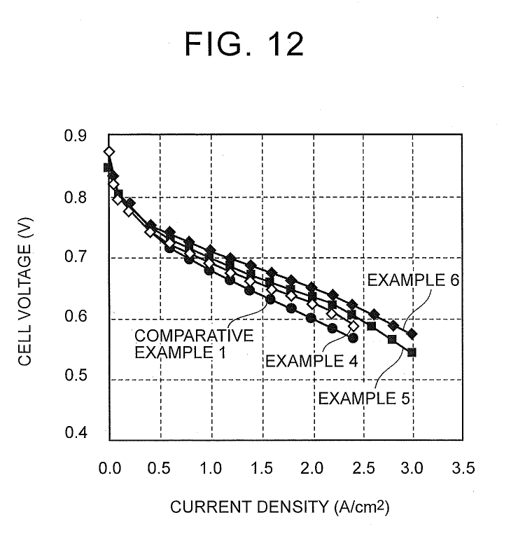

FIG. 12 shows discharge curves of the membrane electrode assemblies of Example 4 to Example 6 and Comparative Example 1. The vertical axis and the horizontal axis in FIG. 12 are the same as FIG. 7. In FIG. 12, a plot with white rhombuses, a plot with black squares, a plot with black rhombuses, and a plot with black circles, respectively, show data of Example 4, data of Example 5, data of Example 6, and data of Comparative Example 1.

As obvious from FIG. 12, Example 4 to Example 6 exhibited the cell voltages higher than that of Comparative Example 1 in a nearly all load current region. That is, the current density at 0.6 V of Example 4 is 2.3 mA/cm², the current density at 0.6 V of Example 5 is 2.5 mA/cm², and the current density at 0.6 V of Example 6 is 2.7 mA/cm². These results show that when there is a certain degree or more of effect of preventing the CNTs from being embedded by disposing the embedment preventive layer, the higher the proton conductivity in the embedment preventive layer is, the more the power generation performance is improved.

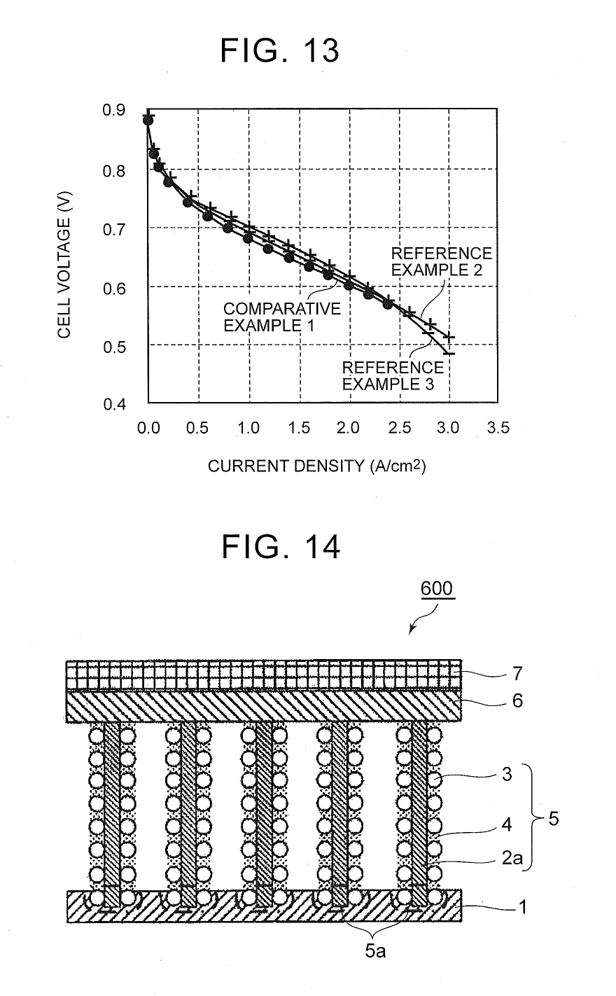

FIG. 13 shows discharge curves of the membrane electrode assemblies of Reference Example 2, Reference Example 3, and Comparative Example 1. The vertical axis and the horizontal axis in FIG. 13 are the same as FIG. 7. In FIG. 13, a plot with white crosses, a plot with crossbars, and a plot with black circles, respectively, show data of Reference Example 2, data of Reference Example 3, and data of Comparative Example 1.

As obvious from FIG. 13, Reference Example 2 and Reference Example 3 exhibited the cell voltages higher than that of Comparative Example 1 in a nearly all load current region. Further, from FIG. 13, the current density at 0.6 V of Reference Example 2 is 2.2 mA/cm², and the current density at 0.6 V of Reference Example 3 is 2.1 mA/cm². Results of Reference Example 2 and Reference Example 3 indicate that since the porosity of the embedment preventive layer is high exceeding 80% and the CNTs are slightly embedded in the embedment preventive layer, these Reference Examples resulted to be lower than Example 4 to Example 6.

Table 4 below is a table in which thicknesses, the basis weights, values of thickness×basis weight, and porosities of the embedment preventive layers and output performances of the membrane electrode assemblies of Example 1 to Example 6 and Reference Example 1 to Reference Example 3 are summarized. In Table 4, a “−” mark indicates that a measurement was not performed.

TABLE 4

| | | | | | Membrane |
|---|---|---|---|---|---|
| | | | | | electrode |
| | Preventive layer for preventing conductive | | | | assembly |
| | nano columnar bodies from being embedded | | | | Output |
| | Thick- | Basis | Thickness × | | performance |
| | ness | weight | basis weight | Poros- | (A/cm² |
| | (μm) | (mg/cm²) | (10⁻⁴ mg/cm) | ity (%) | at 0.6 V) |
| Example 1 | 6.0 | 0.30 | 1.8 | 77.3 | 1.9 |
| Example 2 | 3.0 | 0.30 | 0.90 | 54.5 | 1.9 |
| Example 3 | 2.0 | 0.18 | 0.36 | 59.1 | 2.8 |
| Example 4 | 4.0 | 0.30 | 1.2 | 65.9 | 2.3 |
| Example 5 | 3.25 | 0.225 | 0.73 | 68.5 | 2.5 |
| Example 6 | 3.0 | 0.20 | 0.60 | 69.7 | 2.7 |
| Reference | 2.5 | 0.30 | 0.75 | 45.5 | — |
| Example 1 | | | | | |
| Reference | 3.25 | 0.10 | 0.33 | 86.0 | 2.2 |
| Example 2 | | | | | |
| Reference | 4.25 | 0.125 | 0.53 | 86.6 | 2.1 |
| Example 3 | | | | | |

As described above, in Reference Example 1 where the porosity of the embedment preventive layer is less than 50%, a slight irregularity was generated during the transfer of the CNTs on the embedment preventive layer. On the other hand, in Example 1 to Example 6 and Reference Example 1 to Reference Example 2 where the porosity of the embedment preventive layer is 50% or more and the value of thickness×basis weight of the embedment preventive layer is 1.8×10⁻⁴ mg/cm or less, the current densities at 0.6 V are such high as 1.9 to 2.8 mA/cm².

### DESCRIPTION OF REFERENCE NUMERALS

1/ELECTROLYTE MEMBRANE
1a/PROTON CONDUCTIVE LAYER
1b/PREVENTIVE LAYER FOR PREVENTING CONDUCTIVE NANO COLUMNAR BODIES FROM BEING EMBEDDED
1c/CENTER OF ELECTROLYTE MEMBRANE IN THICKNESS DIRECTION
2/CONDUCTIVE NANO COLUMNAR BODIES
2a/CNT
3/CATALYST
4 ELECTROLYTE MEMBRANE
5/CATALYST LAYER
5a/PART OF CATALYST LAYER
6/POROUS LAYER
7/GAS DIFFUSION LAYER
100/FIRST TYPICAL EXAMPLE OF MEMBRANE ELECTRODE ASSEMBLY ACCORDING TO PRESENT INVENTION
200/SECOND TYPICAL EXAMPLE OF MEMBRANE ELECTRODE ASSEMBLY ACCORDING TO THE PRESENT INVENTION
300/THIRD TYPICAL EXAMPLE OF MEMBRANE ELECTRODE ASSEMBLY ACCORDING TO THE PRESENT INVENTION
400/FOURTH TYPICAL EXAMPLE OF MEMBRANE ELECTRODE ASSEMBLY ACCORDING TO THE PRESENT INVENTION
500/FIFTH TYPICAL EXAMPLE OF MEMBRANE ELECTRODE ASSEMBLY ACCORDING TO THE PRESENT INVENTION
600/CONVENTIONAL MEMBRANE ELECTRODE ASSEMBLY

1. A membrane electrode assembly for a fuel cell comprising:
an electrolyte membrane; and
at least one electrode that includes conductive nano columnar bodies that are disposed at least on one surface of the electrolyte membrane and are oriented in a nearly vertical direction to a surface direction of the electrolyte membrane and a catalyst supported by the conductive nano columnar bodies, wherein:
the electrode membrane includes at least one proton conductive layer and at least one preventive layer for preventing conductive nano columnar bodies from being embedded;
the preventive layer for preventing conductive nano columnar bodies from being embedded is disposed between an interface between the electrode and the electrolyte membrane and a center of the electrolyte membrane in a thickness direction; and
the proton conductive layer occupies a portion other than a portion in which the preventive layer for preventing conductive nano columnar bodies from being embedded is disposed in the electrolyte membrane.

2. The membrane electrode assembly for a fuel cell according to claim 1, wherein:
the membrane electrode assembly includes the electrolyte membrane and one of the electrode;
the electrolyte membrane includes one of the proton conductive layer, and one of the preventive layer for preventing conductive nano columnar bodies from being embedded;
the preventive layer for preventing conductive nano columnar bodies from being embedded is disposed in the interface between the electrode and the electrolyte membrane; and
the proton conductive layer is disposed on a side opposite to the electrode with the preventive layer for preventing conductive nano columnar bodies from being embedded sandwiched therebetween.

3. The membrane electrode assembly for a fuel cell according to claim 1, wherein:
the membrane electrode assembly includes the electrolyte membrane and one of the electrode;
the electrolyte membrane includes two of the proton conductive layer, and one of the preventive layer for preventing conductive nano columnar bodies from being embedded;
the preventive layer for preventing conductive nano columnar bodies from being embedded is disposed in the inside of the electrolyte membrane and between the interface between the electrode and the electrolyte membrane and the center of the electrolyte membrane in the thickness direction; and
two of the proton conductive layer occupy the portion other than the portion where the preventive layer for preventing conductive nano columnar bodies from being embedded is disposed in the electrolyte membrane.

4. The membrane electrode assembly for a fuel cell according to claim 1, wherein:
the membrane electrode assembly includes the electrolyte membrane and two of the electrode;
the electrolyte membrane includes one of the proton conductive layer, and two of the preventive layer for preventing conductive nano columnar bodies from being embedded;
two of the preventive layer for preventing conductive nano columnar bodies from being embedded respectively are disposed in an interface between the electrolyte membrane and one of the electrode and in an interface between the electrolyte membrane and the other of the electrode; and
the proton conductive layer is sandwiched with two of the preventive layer for preventing conductive nano columnar bodies from being embedded.

5. The membrane electrode assembly for a fuel cell according to claim 1, wherein:
the membrane electrode assembly includes the electrolyte membrane and two of the electrode;
the electrolyte membrane includes two of the proton conductive layer, and two of the preventive layer for preventing conductive nano columnar bodies from being embedded;
one of the preventive layer for preventing conductive nano columnar bodies from being embedded is disposed in an interface between one of the electrode and the electrolyte membrane;
the other of the preventive layer for preventing conductive nano columnar bodies from being embedded is disposed in the inside of the electrolyte membrane and between an interface between the other of the electrode and the electrolyte membrane and the center of the electrolyte membrane in the thickness direction; and
two of the proton conductive layer occupy a portion other than a portion where two of the preventive layer for preventing conductive nano columnar bodies from being embedded are disposed in the electrolyte membrane.

6. The membrane electrode assembly for a fuel cell according to claim 1, wherein:
the membrane electrode assembly includes the electrolyte membrane and two of the electrode;
the electrolyte membrane includes three of the proton conductive layer, and two of the preventive layer for preventing conductive nano columnar bodies from being embedded;
one of the preventive layer for preventing conductive nano columnar bodies from being embedded is disposed in the inside of the electrolyte membrane and between an interface between one of the electrode and the electrolyte membrane and the center of the electrolyte membrane in the thickness direction;
the other of the preventive layer for preventing conductive nano columnar bodies from being embedded is disposed in the inside of the electrolyte membrane and between an interface between the other of the electrode and the electrolyte membrane and the center of the electrolyte membrane in the thickness direction; and
three of the proton conductive layer occupy a portion other than a portion where two of the preventive layer for preventing conductive nano columnar bodies from being embedded are disposed in the electrolyte membrane.

7. The membrane electrode assembly for a fuel cell according to claim 1, wherein the preventive layer for preventing conductive nano columnar bodies from being embedded includes a proton conductive electrolyte resin and a porous resin harder than the proton conductive electrolyte resin.

8. The membrane electrode assembly for a fuel cell according to claim 1, wherein a thickness of the preventive layer for preventing conductive nano columnar bodies from being embedded is 1 to 10 μm.

9. The membrane electrode assembly for a fuel cell according to claim 1, wherein a basis weight of the preventive layer for preventing conductive nano columnar bodies from being embedded is 0.05 to 1.0 mg/cm².

10. The membrane electrode assembly for a fuel cell according to claim 7, wherein, when a total volume of the preventive layer for preventing conductive nano columnar bodies from being embedded is set to 100% by volume, a volume of the proton conductive electrolyte resin is 10 to 90% by volume.

11. The membrane electrode assembly for a fuel cell according to claim 1, wherein the preventive layer for preventing conductive nano columnar bodies from being embedded is disposed in a portion having a thickness of 0 to 5 μm from an interface with the electrode toward the thickness direction of the electrolyte membrane.

12. The membrane electrode assembly for a fuel cell according to claim 1, wherein the conductive nano columnar body is a carbon nano tube.

13. The membrane electrode assembly for a fuel cell according to claim 1, wherein a cathode electrode includes the conductive nano columnar body.

14. The membrane electrode assembly for a fuel cell according to claim 1, wherein the porosity of the preventive layer for preventing conductive nano columnar bodies from being embedded is 50% or more, and a product of the thickness and the basis weight of the preventive layer for preventing conductive nano columnar bodies from being embedded is 1.8×10⁻⁴ mg/cm or less.

15. The membrane electrode assembly for a fuel cell according to claim 8, wherein, when a total volume of the preventive layer for preventing conductive nano columnar bodies from being embedded is set to 100% by volume, a volume of the proton conductive electrolyte resin is 10 to 90% by volume.

16. The membrane electrode assembly for a fuel cell according to claim 9, wherein, when a total volume of the preventive layer for preventing conductive nano columnar bodies from being embedded is set to 100% by volume, a volume of the proton conductive electrolyte resin is 10 to 90% by volume.
